(19) United States
(12) Patent Application Publication
(10) Pub. No.: US 2023/0394233 A1
(43) Pub. Date: Dec. 7, 2023

(54) SYSTEM, SERVER AND METHOD FOR TRAINING ARTIFICIAL INTELLIGENCE USING VECTORIZED DATA

(71) Applicant: Blayne Lequeux, Dana Point, CA (US)

(72) Inventor: Blayne Lequeux, Dana Point, CA (US)

(21) Appl. No.: 18/450,894

(22) Filed: Aug. 16, 2023

Related U.S. Application Data
(63) Continuation-in-part of application No. 16/849,312, filed on Apr. 15, 2020.
(60) Provisional application No. 62/847,469, filed on May 14, 2019.

(51) Int. Cl. G06F 40/205; G06F 40/47

(52) U.S. Cl. CPC G06F 40/205; G06F 40/47

(57) ABSTRACT

In some embodiments, the disclosure is directed to a system for training artificial intelligence. In some embodiments, the system is configured to generate an array of vectors derived from names, addresses, proper nouns, companies, and/or any other identifier of an individual. In some embodiments, the array is used to train the AI to recognize the variations of an identifier. In some embodiments, the system instructs the AI to search one or more databases to look for the variations of the identifier. In some embodiments, information linked to the variations are used to by the AI to determine additional variations, which are then added to the array as a new training set. In some embodiments, the process repeats until all variations of an identifier for an individual have been entered into the array. In some embodiments, at least a portion of the information associated with each variation is also stored.

### CROSS-REFERENCE TO RELATED APPLICATIONS

This application is a Continuation-in-Part of U.S. patent application Ser. No. 16/849,312, filed Apr. 15, 2020, which claims the benefit of and priority to U.S. Provisional Application No. 62/847,469, filed May 14, 2019, entitled “Healthcare Identification Cloud System, Server and Method”, the entire contents of which are incorporated herein by reference.

### BACKGROUND

There have been revolutionary advancements in data gathering over the last century. Today, multiple organizations keep troves of records about an individual's preferences and history. The most common practice is to associate each record with a unique identifier, such as the person's name, so that a search for that unique identifier retrieves all associated records. This record retrieval is sometimes performed across multiple databases. However, different databases made by different software manufactures are not always compatible, and do not always communicate with each other. This can cause major problems, especially in the healthcare industry.

Even systems that do communicate with each other, such as healthcare and law enforcement databases, are not always able to properly identify an individual due to various names used as identifiers at different times and/or across different databases. Name variations that refer to the same individual might be the result of a name change after a marriage, might result from the use of middle names and nicknames as part of the identifier, might be from mistakes made from manual data entry, may be from the sale or restructuring of a corporation, etc.

To exacerbate the problem, there are countless individuals that have the same name. To combat confusion, prior art systems typically associate a person's name with additional identifying information such as an address, a driver's license number, a social security number, a telephone number, or some other unique identifier. A problem that exists currently in the art is that there is no consistency: one prior art system may use one additional identifier type, while another system may choose to use a different type. Changes in an individual's address, telephone number, or a driver's license number, can also cause breaks in record links as not all databases are updated when a unique identifier has changed.

Compounding problems with record retrieval even further, a system of updating unique identifiers across multiple industries has not yet been achieved due to privacy concerns. Some system databases do not allow access to records where the name and corresponding identifying information is not an exact match. Some databases do not allow outside access for any reason. However, the identification variations that hold the key to linking multiple records across different industries is currently locked away in distributed systems.

Healthcare professionals are issued CMS National Provider Identifier (NPI) numbers; however, organizations can have many NPIs. Providers are notorious for not maintaining their demographic data current. In addition, every person uses multiple identifiers. While Social Security Numbers are a unique identifier for an individual, Social Security Numbers are illegal for general use in healthcare. Furthermore, millions of people are not identified or do not want to be identified and many providers submit claims through different identities. All health plans have their own patient and provider identifiers which are linked to claims.

In conventional methods, business and accounting processes are managed by thousands of paper and computer systems, which cannot attempt to relate hundreds of millions of varying identifiers for providers, patients and service organizations. In these conventional systems, names are entered into computers from handwritten forms or verbal spellings as well as addresses and phone numbers.

The average health plan member creates about a dozen claims per year and each claim is reviewed by dozens of plan functions and ancillary organizations with a financial interest in the claim. Each plan member's claims are reviewed 3 to 5 times creating approximately billions of identification events per year. Even if all identifiers were accurately recognized the overhead burden is significant. If an identification error occurs anywhere in the adjudication process then the claim is pended for review, identification and reprocessing. It is common in healthcare for bills to be sent multiple times due to processing lag, identification errors, reprocessing and late payment cycles.

The lack of a comprehensive identification system has led to massive fraud and abuse as well as overutilization cost. An investigation of a chiropractor found that he operated under a personal NPI and 3 corporate NPIs and prescribed $8 M in compounded drugs which included narcotics and $22 M through his company which were all paid legally. The person and the company were shut down but kept the money. A major health plan paid all podiatrists' claims for years and then determined that about 1,000 were prescribing compounded drugs with narcotics costing the plan $65 M per year. The Federal government issues DEA numbers for prescribers but stopped managing the process years ago. Now almost anybody in healthcare can prescribe any drug. These are all example identification problems with high-cost impact.

Reimbursement for healthcare services offered to 300+ million people in the US, provided by 15 million medical professionals and organizations, supported by 10 million workers in insurance, administrative and ancillary services organizations have surpassed $3.6 trillion annually. Conservative estimates assign over 28% ($1 Trillion) in losses every year to fraud, waste and abuse. The vast majority of efforts to stem these losses require accurate reference data as an imperative. Table A below shows current healthcare segments and their corresponding segment percentage and projected participants.

TABLE A

| Healthcare | Segment | Projected |
|---|---|---|
| Segments | Percentage | Participants |
| Employer | 49% | 163,660,000 |
| Non-Group | 6% | 20,040,000 |
| Medicaid | 20% | 66,800,000 |
| Medicare | 14% | 46,760,000 |
| Military | 1% | 3,340,000 |
| Uninsured | 9% | 30,060,000 |

| | |
|---|---|
| 2021 Total USA | 334,000,000 |

Compiling a comprehensive healthcare history can be confounded by multiple variations of a name. When attempting to compile a complete profile on an individual, such as for healthcare, advertisement or law enforcement purposes, the different name variations in different databases (social media, shopping, billing, etc.) make it almost impossible to capture all of an individual's data. Therefore, there is a need for a system that is able to identify an individual and/or entity or agency by using a combination of unique identifiers of name variations to train an artificial intelligence system to identify further name variations and activity associated therewith to gain a complete understanding of a user's history.

### SUMMARY

In some embodiments, the disclosure is directed to a computer-implemented method for training an artificial intelligence system. Some embodiments comprise a step of receiving, by one or more processors, one or more identifiers for one or more individuals from one or more databases. Some embodiments comprise a step of executing, by the one or more processors, a vectorization of the one or more identifiers, where the vectorization generates one or more vectors by transforming each of the one or more identifiers into a vector identifier. Some embodiments comprise a step of generating, by the one or more processors, an array comprising the one or more vectors generated from each of the one or more identifiers. Some embodiments comprise a step of sending, by the one or more processors, the array to an artificial intelligence module as a training set for an artificial intelligence.

In some embodiments, generating one or more vectors comprises a character classification of one or more characters within each of the one or more identifiers. In some embodiments, the character classification includes separating text, strings, spaces, hyphens, periods, prefixes, suffixes, titles, and/or numbers into elements. In some embodiments, each of the one or more vectors comprise a plurality of the elements.

Some embodiments comprise a step of executing, by the one or more processors, a database search for a form of the one or more vectors. Some embodiments comprise a step of returning, by the one or more processors, identifying information associated with the one or more vectors. Some embodiments comprise a step of generating, by the one or more processors, one or more new vectors by transforming each of one or more identifier variations into a new vector identifier, Some embodiments comprise a step of storing, by the one or more processors, the one or more new vectors in the array to generate a new array.

Some embodiments comprise a step of sending, by the one or more processors, the new array to the artificial intelligence module as a new training set. Some embodiments comprise a step of repeating, by the one or more processors, additional database searches until no additional identifying information and/or identifier variations are discovered. Some embodiments comprise a step of sending, by the one or more processors, additional arrays generated during the repeating to the artificial intelligence module as additional training sets.

Some embodiments comprise a step of generating, by the one or more processors, a unique identification for each of the one or more vectors in the array. Some embodiments comprise a step of generating, by the one or more processors, a master identification configured to reference each unique identification, Some embodiments comprise a step of associating, by the one or more processors, the master identification with at least one of the one or more vectors.

In some embodiments, receiving, by the one or more processors, a query comprising at least one instance of an identifier in the array. Some embodiments comprise a step of returning, by the one or more processors, all records associated with each variation in the array for the one or more individuals. In some embodiments, the one or more identifiers includes a proper noun.

Some embodiments include systems and methods of identifying individuals, patients, employees, entities, corporations, products, structures, landmarks, computer programs, and/or anything that can be identified by a proper name (hereafter an/the “individual” and/or “individuals”). In some embodiments, the system identifies individuals by collecting, storing, analyzing, processing, and publishing multiple variations of identifying information associated with an individual. In some embodiments, the system associates one or more of those variations with the distributed systems' records.

In some embodiments, the system includes a cloud-based reference service provided through a computer-to-computer function called a web service that automatically reviews and uniquely identifies all parties to a healthcare transaction or claim. In some embodiments, this Web service is callable by any Web-connected administrative system using a function that submits one or more transactions which are identified, and correct identifiers and verified names and demographic data are appended to each record in milliseconds per record. In some embodiments, if a record cannot be automatically identified, it is pended, and a reviewer resolves and releases the record to the client. In some embodiments, identities may be manually researched by an individual in a Web browser.

Problems with name matching methods used in the prior art include being unable to search multiple databases accurately due to differences in database formats as well as the inaccurate and delayed delivery of results. In some embodiments, the system described herein is configured to implement a search of multiple databases and return the results in less than 50 ms. FIG. 7 depicts a non-limiting example of the different types of domains and the relationships between the domains according to some embodiments.

In some embodiments, the system includes Service Offerings. In some embodiments, Comprehensive Data-as-a-Service (DaaS) Web services are configured for accepting a single entry or batch file to find a person, organization, or healthcare provider (professional or institution) and return a fixed format response. In some embodiments, the system includes Basic and smart DaaS APIs configured to help customers answer a variety of commercial questions.

In some embodiments, the system includes a Learning Database. In some embodiments, a Learning Database retains variations of identifiers (e.g., individuals, organizations, relationships, and/or addresses). In some embodiments, the system includes a learning database technology that records variations of a name of an individual, entity, organization, address and other defining attributes. In some embodiments, the system is configured to store variable data (i.e., variations of data, where data is a reference to any type of identifying information (ID) associated with an individual) in a proprietary variations database. In some embodiments, a variations database (e.g., a variations table) is used for identification and managed by the system via a logic system and rules tables. In some embodiments, individuals, organizations and addresses that cannot be automatically identified may be resolved through other data sources or manually. In some embodiments, the system is configured such that the frequency of names matches for master and errata names are recorded and the source data of each change is recorded along with the date and time. In some embodiments, Unique IDs are stored for each address for an individual and organization along with the data source and date. In some embodiments, the rules match logic will be enhanced using system logic along with matching the individual person's identity to the professional provider identity.

In some embodiments, the system includes a web portal that offers a single-line entry to identify people, organizations, and healthcare institutions and providers by defining parameters such as geography, people demographics, etc. In some embodiments, the system is configured to allow users to design and produce reports and perform analyses incorporating statistics, sorting, artificial intelligence and graphic mapping displays.

In some embodiments, the system's AI and or machine learning is configured to learn through iterative use. In some embodiments, iterative use of the service enhances the system because the source data and logic for every edit is retained. In some embodiments, the web user interface is configured to guide the user through a process of finding information, answering questions, and adjusting the user interaction based on the experience history of the user. In some embodiments, the system is configured for source data maintenance using web services and automated, secure FTP sites to intake, process, edit, refine and load into the system to create the output of clean client data. In some embodiments, artificial intelligence is implemented after one or more searches and/or logic programs are implemented in order to save computer resources. In some embodiments, implementing artificial intelligence is not the first step in identifying multiple, non-linked patient records.

In some embodiments, the system includes one or more databases with data about people, organizations, locations, identifiers, demographics, and attributes. In some embodiments, the system includes a population database which uniquely identifies millions (e.g., 285 million-plus) of individual people using multiple attributes (e.g., 400-plus attributes). In some embodiments, the system includes an organization database that uniquely identifies public, private, social, industry and governmental organizations (e.g., 20 million-plus agencies) with attributes (e.g., 300-plus attributes) and tracks related individuals. In some embodiments, the system includes an address database for addresses, misspellings, Latitide (Lat) and Longitude (Lon), and other geographic definitions (e.g., for maintaining the 150 million-plus addresses in the USA).

In some embodiments, the system uses one or more of uniquely identifying information such as one or more current and/or past names, addresses, driver's license numbers, social security number, telephone numbers, pictures, computer readable code, fingerprints, retinal scans, biometric data, metadata (e.g., digital footprints such as driving patterns, purchase patterns, web browser history, etc.), public and/or private records, and/or any other type of identifier associated with an individual to confirm the individual's identity. In some embodiments, name variations can include nicknames, surnames, titles, given names, family names, aliases, usernames, corporate names and/or any title an individual may use for identification purposes. Uniquely identifying information and the variation thereof are collectively referred to as an identifier(s), and/or an ID(s) herein.

In some embodiments, the system provides significant performance improvements over the prior art. In some embodiments, improvement in performance is obtained by first placing patient information from one or more databases into a vector before any further logic is implemented. A non-limiting program execution flow is illustrated in table 2 according to some embodiments. Unlike conventional “string” parsing methods, by first placing identifying information (e.g., name, address, title, etc.) into a vector some embodiments of the system provide significant increases in accuracy with shorter processing times and associated lower computer resource utilization. In some embodiments, implementing a vector transformation is configured to take disparate information about an individual (which might include errors such as double spaces) and places it into a single row for analysis. After the IDs are placed in a vector, the parsing step can be implemented. In some embodiments, this novel method of improving computer efficiency also enables multiple database types to be analyzed as the first step is to place the data from each database into the vector format. Empirical results show a 20%-80% improvement of patient identification in any single database and/or multiple database ID matching executed simultaneously. In some embodiments, vectoring an ID can improve the speed of returning matching records up to over 100 times that of conventional methods.

In some embodiments the system is used by healthcare industries. In some embodiments, the system allows for different healthcare systems to communicate information about individuals. In some embodiments, different healthcare systems identify patients using different IDs. In some embodiments, the system creates a database including all the different IDs that have been associated with an individual. In some embodiments, advanced scouring tools are used to gather IDs from multiple online systems to create a database of IDs associated with an individual. In some embodiments, the system is shared by healthcare agencies, law enforcement agencies, government agencies, marketing agencies, and/or any individual, organization, or corporation (collectively referred to as an “agency” and/or “agencies”). In some embodiments, agencies use one or more identifiers to associate one or more documents, records, links, and/or data (collectively referred to as data) with a single individual. In some embodiments, the system is used by one or more agencies to identify an individual associated with multiple IDs.

In some embodiments, the system is configured for general use anywhere in the $4 trillion U.S. healthcare system. In some embodiments, the system is configured for tracking and identifying individuals during an epidemic to track the source and/or positively identify specific individuals who may have come into contact with each other. In some embodiments, the system is configured to compare records (e.g., credit card usage; phone records; entry logs; metadata) from one individual's ID to another individual's ID such that infected individuals can be tracked and/or notified. In some embodiments, the system if fully implemented by agencies would have helped mitigate the effects of the Corona Virus outbreak of 2020, for example.

Some embodiments include a system, server and method comprising at least one processor, and at least one non-transitory computer-readable storage medium in data communication with the at least one processor that is configured to store and exchange data comprising or representing data derived or received from at least one server of at least one data source, database, and/or at least one user. Some embodiments include an application programming interface (API) in data communication with at least one processor and at least one non-transitory computer-readable storage medium. In some embodiments, the application programming interface includes steps executable by at least one processor to upload, download, or enable access of the content data derived or received from at least one server of at least one healthcare data source and/or at least one user. FIG. 5 shows an access restriction GUI according to some embodiments.

In some embodiments, one or more of: outpatient, inpatient, prescription, laboratory, dental and vision claims are retained in a cloud system. In some embodiments, the outpatient, inpatient, prescription, laboratory, dental and vision claims can be linked to patients, providers and health plans in a manner that facilitates one or more of the following: near real-time, bi-directional updating of data sources with a healthcare data cloud system master database; access to interactive web browsers for real-time and batch processes for queries, reports, analysis and research purposes; individuals making inquiries for claims, eligibility, health profiles, benefits, electronic medical records, questions and answers, finding in-network doctors, labs, outpatient facilities, pharmacies, and the like; analysis of provider networks, provider assessment, network optimization; and actuarial underwriting, claims modeling, analysis of group plans and loss-ratio projections.

In some embodiments, communication with the system occurs interactively through a web browser. In some embodiments, the system can use a natural language interface. In some embodiments, the natural-language interface allows a user to communicate with the system using common linguistic sentences, phrases, questions, and/or clauses to select, modify, and/or create data. In some embodiments, the healthcare data cloud system uses automated web services for computer-to-computer transactions. In some embodiments, automated web services allow software that may have different programming languages to communicate over a network (e.g., the World Wide Web). In some embodiments, application programming interfaces (APIs) enable communication between different types of software. In some embodiments, the system can use an automated and interactive file transfer protocol website. In some embodiments, one or more interactive file transfer protocol websites enable file uploads and downloads.

In some embodiments, the system includes a Natural Language Processing System (NLPS). In some embodiments, the system includes a Natural Language Variations Table (NLVT). In some embodiments, a Web page for user input and requests consists of a single line entry using natural language to query the system, produce reports, load and edit data and numerous other user functions. In some embodiments, the NLPS is focused on healthcare applications and terminology referring to medical diagnoses and procedures and terms applying to healthcare claims for outpatient and inpatient services. In some embodiments, if the user uses an unrecognized term the system will attempt to relate the entry to similar terms in the NLVT. In some embodiments, if relating the entry to similar terms in the NLVT is successful, the system is configured to store the term for the user. In some embodiments, if relating the entry to similar terms in the NLVT is unsuccessful, the system is configured to enable manual entry of the term (e.g., the term is researched by a technician and new terms are added to the system). In some embodiments, the NLPS includes all data definitions and variations from the DIMU and DMU then into the NLVT. Reports and terms created in the RDMU are also incorporated into the NLVT and can be referenced in a natural language user request. Individual names and organizations entered through the NLPS are recognized using the functions of the IMU and the related variations tables.

In some embodiments, the systems and data sets are designed to incorporate deep learning and artificial intelligence. In some embodiments, systems and data sets can give fast access and analysis of vast amounts of data. In some embodiments, systems and data sets can improve healthcare and healthcare costs. In order to meet these goals, some embodiments of the healthcare data cloud system are configured to respond to questions. In some embodiments, example input questions and system responses are as follows:
Descriptive question: What happened?
   System response: A person has congested lungs.
Diagnostic question: Why did it happen?
   System response: The person contracted a virus that damages the lungs and creates a fluid discharge that fills the lungs.
Predictive question: What will happen?
   System response: If the person does not stop the viral activity to inhibit the damage to the lungs and clear the fluid the person will likely die.
Prescriptive question: What should be done?
   System response: Drugs should be administered to kill the virus and all people exposed to the patient should be given an antiviral drug blocking the virus.

In some embodiments, the Healthcare Data (Cloud) System (the “system”; HDCS) addresses a major problem in healthcare: the unique identity of people, patients, healthcare providers, organizations, family relationships, employment relationships, provider network relationships, health plan identities and relationships to all related parties. In some embodiments, unique identities are required for assigning symptoms, diagnoses, prescriptions, procedures, reimbursement for services, claims, eligibility and endless other processes and administrative requirements. In some embodiments, the system is configured to uniquely identify individuals, organizations, and healthcare providers at any point in time. In some embodiments, this is based upon one or more (e.g., billions of) attributes. In some embodiments, the system is configured to return the information in less than 50 milliseconds. In some embodiments, the system is configured to scale in a cloud environment and/or is configured to automatically invoke additional servers to process large amounts of records. In some embodiments, the identification process is (100%) deterministic, not probabilistic, and/or incorporates proprietary matching logic and/or artificial intelligence solutions.

In some embodiments, the system is configured to be at least partially integrated and optimized into a distributed and/or hybrid cloud environment. In some embodiments, data processed by the system includes people, organizations, locations, payers, and/or thousands of attributes as non-limiting examples. In some embodiments, the system includes a population platform and/or database that uniquely identifies (e.g., 300 million-plus) individual people. In some embodiments, each person includes (e.g., 400-plus) attributes and related health history. In some embodiments, the system includes an organization platform and/or database that uniquely identifies 20 million-plus public, private, social, industry and governmental organizations with 300-plus attributes and/or tracks related individuals. In some embodiments, the system includes an address platform and/or database for the USA maintaining 150 million-plus addresses, misspellings, latitude, and longitude, and/or other geographic definitions.

In some embodiments, the system includes a learning platform and/or database. In some embodiments, the learning platform is configured to retain all information including errata of all individuals and organizations accessible by the system. In some embodiments, the learning platform is configured to execute program steps to identify variations of a name of an individual, entity, organization, address and defining attributes. In some embodiments, the system is configured to store the identified variable data in a (proprietary) one or more errata files which are used for identification and/or are managed by one or more logic system and rules tables. Individuals, organizations and addresses that cannot be automatically identified may be resolved through other platforms or manually according to some embodiments.

In some embodiments, the frequency of name matches for master and errata names are recorded by the system and/or the source data of each change is recorded along with the date and time. In some embodiments, unique IDs are stored for each address for an individual and organization along with the data source and date. In some embodiments, the system is configured to enhance the rules using matching logic along with matching the individual person identity to the professional provider identity.

In some embodiments, the system includes a graphical user interface (e.g., web interface) configured to guide a user through a process of finding information, answering questions and adjusts the user interaction based on the experience history of the user.

In some embodiments, source data maintenance is executed by the system using web services and/or automated, secure FTP sites to intake, process, edit, refine, and load into the HISC and create an output of clean client data.

In some embodiments, the system includes cloud service technology. In some embodiments, the system includes comprehensive Data-as-a-Service (DaaS) APIs capable of accepting a single entry or batch file to find a person, organization, or healthcare provider (professional or institution) and returning a fixed format response. In some embodiments, basic and smart DaaS APIs are used by the system to answer a variety of commercial questions for large amounts of data. In some embodiments, the system includes one or more web portals that offer a single-line entry to find people, organizations, and healthcare institutions and providers by defining parameters such as, but not limited to, geography, people demographics, disease states, procedures, diagnoses, etc. In some embodiments, the system is configured to enable users to design and produce reports and perform analyses incorporating statistics, sorting, artificial intelligence, and graphic and mapping displays.

### BRIEF DESCRIPTION OF THE DRAWINGS

FIG. 1 illustrates the resulting parsed vector for an individual's name and address according to some embodiments.

FIG. 2 illustrates a flowchart for building an AI model according to some embodiments.

FIG. 3 illustrates a logic execution map according to some embodiments.

FIG. 4 depicts a crosswalk table execution map according to some embodiments.

FIG. 5 shows an access restriction GUI according to some embodiments.

FIG. 6 illustrates a dynamic schema table model according to some embodiments.

FIG. 7 shows a non-limiting example of an address record schema according to some embodiments.

FIG. 8 illustrates a flow chart of a hybrid cloud system according to some embodiments.

FIG. 9 illustrates a flow chart of the system's operations according to some embodiments.

FIG. 10 illustrates a flow chart of Population, Organizations, Addresses and Healthcare Tables according to some embodiments.

FIG. 11 illustrates an example service market the system is configured to support according to some embodiments.

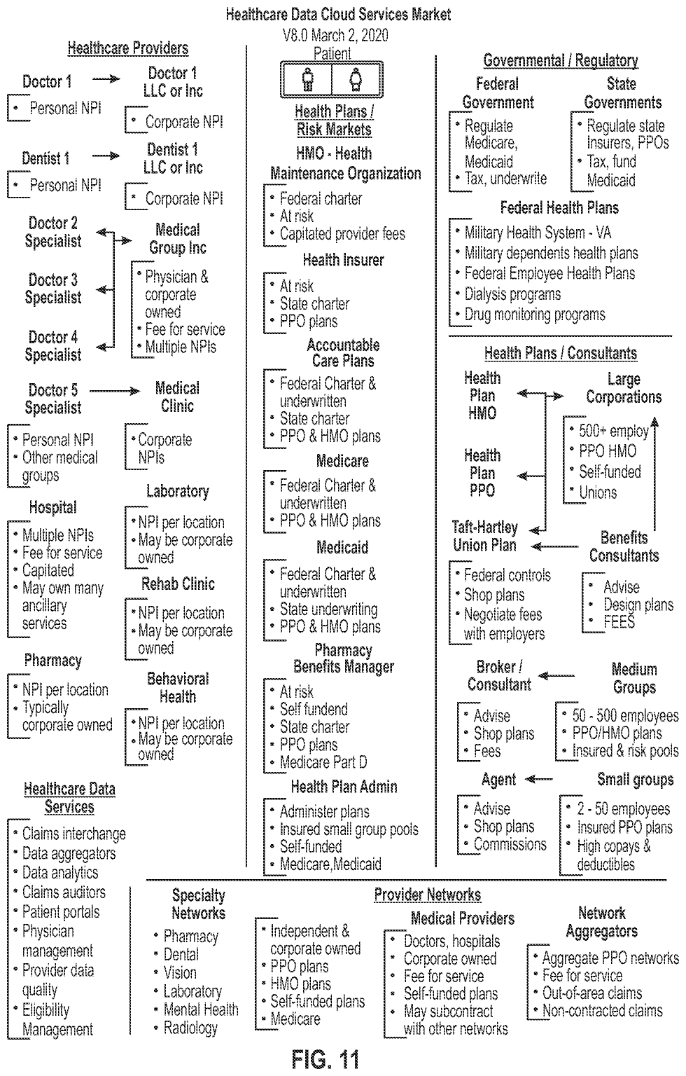

FIG. 12 illustrates a computer server system network in communication with the system according to some embodiments.

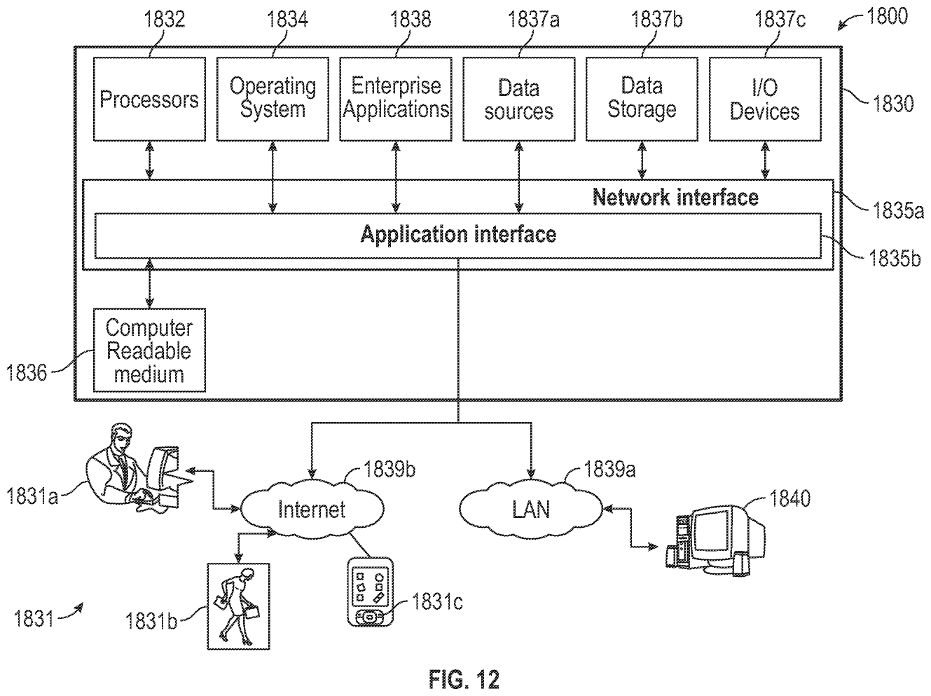

FIG. 13 illustrates another flow chart of the system's operations and components according to some embodiments.

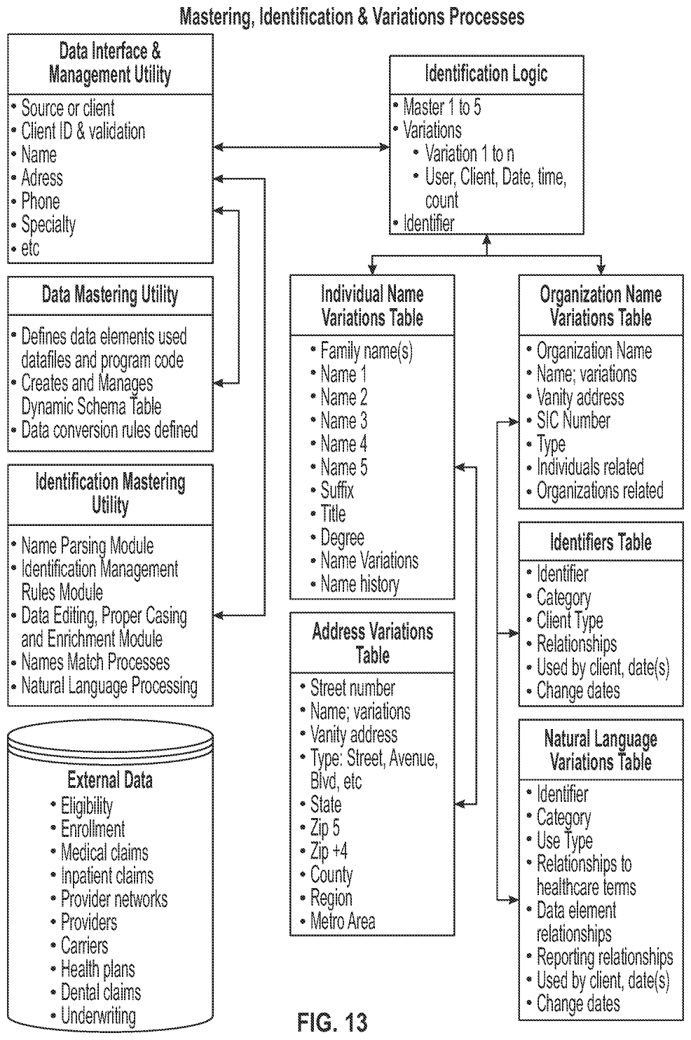

### DETAILED DESCRIPTION

In some embodiments, the disclosure is directed to a system for training an artificial intelligence (also referred to herein as “AI”) system. In some embodiments, the system includes one or more computers comprising one or more processors and one or more non-transitory computer readable media. In some embodiments, the one or more non-transitory computer readable media comprise program instructions stored thereon that when executed cause the one or more computers to implement one or more steps. Some embodiments comprise a step of receiving, by the one or more processors, one or more identifiers for one or more individuals. Some embodiments comprise a step to execute, by the one or more processors, a vectorization of the one or more identifiers, where the vectorization generates one or more vectors by transforming each of the one or more identifiers into a vector identifier. Some embodiments comprise a step to generate, by the one or more processors, an array comprising the one or more vectors generated from each of the one or more identifiers. Some embodiments comprise a step to send, by the one or more processors, the array to an artificial intelligence module as a training set for the artificial intelligence.

In some embodiments, generating the one or more vectors comprises a character classification of one or more characters within each of the one or more identifiers. In some embodiments, the character classification includes separating text, strings, spaces, hyphens, periods, prefixes, suffixes, titles, and/or numbers into elements. In some embodiments, each of the one or more vectors comprise a plurality of the elements.

In some embodiments, the one or more non-transitory computer readable media further comprise program instructions stored thereon that when executed cause the artificial intelligence to execute, by the one or more processors, a database search using the array. Some embodiments comprise a step to return, by the one or more processors, identifying information associated with a form of the one or more vectors. In some embodiments, a form includes a string of characters matching the order and/or elements of a vector. In some embodiments, the one or more non-transitory computer readable media further comprise program instructions stored thereon that when executed cause the artificial intelligence to search, by the one or more processors, the identifying information for one or more identifier variations associated with the one or more individuals. Some embodiments comprise a step to store, by the one or more processors, the one or more identifier variations.

In some embodiments, the one or more non-transitory computer readable media further comprise program instructions stored thereon that when executed cause the artificial intelligence to generate, by the one or more processors, one or more new vectors by transforming each of the one or more identifier variations into a new vector identifier. Some embodiments comprise a step to store, by the one or more processors, the one or more new vectors in the array to generate a new array. Some embodiments comprise a step to send, by the one or more processors, the new array to the artificial intelligence module as a new training set. Some embodiments comprise a step to repeat, by the one or more processors, additional database searches until no additional identifying information and/or identifier variations are discovered.

In some embodiments, the one or more non-transitory computer readable media further comprise program instructions stored thereon that when executed cause the artificial intelligence to generate, by the one or more processors, a unique identification for each of the one or more vectors in the array. Some embodiments comprise a step to generate, by the one or more processors, a master identification configured to reference each unique identification. Some embodiments comprise a step to associate, by the one or more processors, the master identification with at least one of the one or more vectors.

In some embodiments, the one or more non-transitory computer readable media further comprise program instructions stored thereon that when executed cause the one or more computers to receive, by the one or more processors, a query comprising at least one instance of an identifier in the array. Some embodiments comprise a step to return, by the one or more processors, all records associated with each variation in the array for the one or more individuals.

In some embodiments, the systems and methods described herein are directed to building a master database. In some embodiments, the master database is configured to cause one or more computers to be able to search for an individual faster, more efficiently, and/or accurately than prior art systems. In some embodiments, it is the resulting searchable structure that enables a computer to accomplish the task of identifying an individual in a specific time period (e.g., 50 ms).

In some embodiments, building the master database includes a preparation step. In some embodiments, the master database requires a substantial amount of computer resources. In some embodiments, a resulting non-limiting population database generated by the system includes 314 million records of adults 18 and over. In some embodiments, the system includes one or more (e.g., 9) historical database years, each with fewer records, fewer data elements and reduced quality. Some embodiments comprise a step of rolling forward population data. In some embodiments, rolling forward includes tracking one or more of name, address changes, households, employer relationships, all variations, and errata, etc. In some embodiments, this is a long, complicated process that uses every component of the system described herein.

In some embodiments, once the database structure has been built the identification system process flow includes sorting, by the one or more processors, the population table by last name, first name and Zip code order. Some embodiments comprise a step of processing one or more (e.g., every) name using the Identification-Match system. Some embodiments comprise a step to process, by the one or more processors, one or more complete match failures is processed manually and/or using AI. In some embodiments, manual and/or AI processing includes searches using the internet and/or externally licensed databases and other identification services.

In some embodiments, the resulting database creates a search engine based on a vector and array labeling structure. In some embodiments, the resulting database includes 200 million plus uniquely identified adults in the US, billions of related addresses, phone numbers, emails, etc., billions of relationship identifiers, and/or hundreds of billions of errata vectors.

In some embodiments, the identification of an individual or an entity is accomplished using numerous identifiers (parameters and tensors) including names, addresses, phone numbers, employers, relationships with other individuals in a family or location or organizations, income, interests, purchasing habits, demographics of their geographic areas, and the frequency with which identifiers occur. In some embodiments, the system is configured to keep track of all identifiers, variations of identifiers and/or erroneous identifiers referred to as errata. In some embodiments, the system records the first encounter date and time of an identifier, the running total of encounters of an identifier and/or the date and time of the most recent encounter. In some embodiments, one or more of these are combined into one or more vectors (e.g., person, address, etc.) that identify an individual. In some embodiments, the vector includes a person vector.

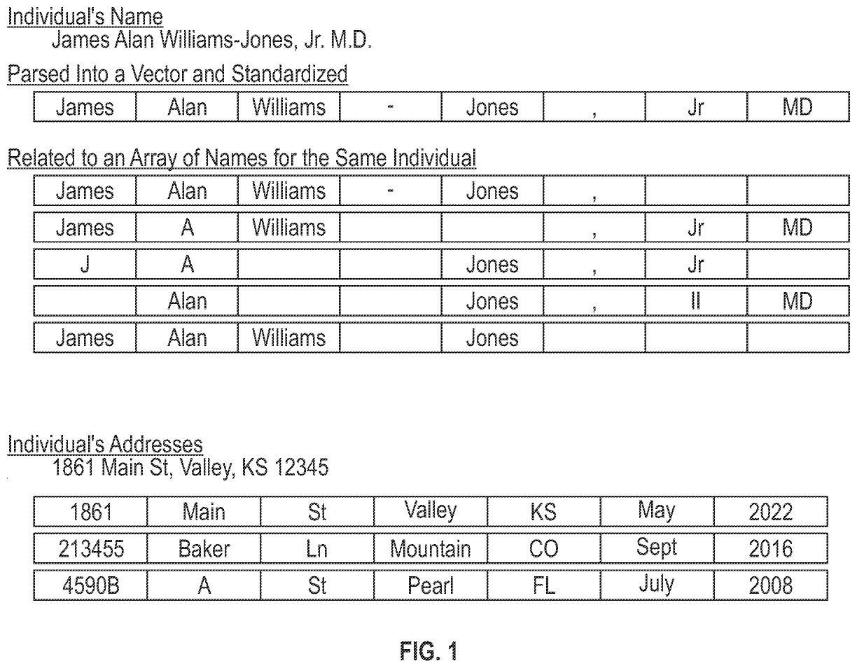

FIG. 1 illustrates the resulting parsed vector for an individual's name and address according to some embodiments. In some embodiments, the identification system is configured to place every component of a name into a vector format. In some embodiments, the system is configured to remove and/or not store one or more (e.g., all) control characters, extra spaces, and/or periods from the name and the names are standardized in the vector.

In some embodiments, the system is configured to store one or more of the original name entry, the standardized name, every recorded combination of name and erroneous versions of a name in vector format. In some embodiments, the system is configured to store, the (initial) date and/or time of an encounter of the name, the number of encounters, and/or the date and/or time of the most recent encounter. In some embodiments, the system is configured to apply this process to all valid names, variations of a name, and/or erroneous entries of a name (a reference to a name is also a reference to addresses, companies, and/or any proper noun uniquely identifying a person or place).

In some embodiments, the system is configured to assign and/or retain a Unique ID to every vector that is part of an array defining attributes of an individual: Unique ID for a name vector, Unique IDs of the related name in the master table, Unique IDs if related organizations, etc. In some embodiments, every variation of a person's record is linked to the master record ID. In some embodiments, during the match process, all unique ID vector records pertaining to a master record are read into an array where matching code processes more records at speeds faster and more accurately than search databases of the prior art.

In some embodiments, the system is configured to generate and/or store an address vector. FIG. 1 also illustrates an address vector according to some embodiments. In some embodiments, the system is configured to parse addresses into a vector that includes one or more of street number, street name, type (St, Ave, Blvd, Ln, etc), suffix, pre-directional, Address 2 (suite, apartment number), post office (PO), rural free delivery (RFD), road (RD), State and/or ZIP. In some embodiments, the system is configured to process one or more (e.g., all) addresses through one or more conventional USPS certified address verifiers to determine if it is deliverable and meets the standard formatting and abbreviations.

In some embodiments, the system is configured to parse all addresses into a vector. In some embodiments, the original address entry, the standardized address, every recorded combination of addresses and/or erroneous versions of a name are placed into a vector. In some embodiments, the initial date and time of encounter of the address, the number of encounters and the date and time of the most recent encounter are recorded by the system. In some embodiments, the system is configured to apply this process to all valid addresses, variations of an address and erroneous entries of an address. In some embodiments, the system is configured to apply editing and standardization rules to each address.

In some embodiments, the system is configured to execute, by the one or more processors, an organization and relationships process. In some embodiments, in some embodiments, the system is configured to record relationships between organizations and/or the type of relationships. In some embodiments, the system is configured to record one or more (e.g., all) individuals related to an organization and/or the type of relationship along with titles, function, emails and/or phone numbers, as non-limiting examples. In some embodiments, the initial date and time of encounter of an organization's name, the number of encounters and the date and time of the most recent encounter are recorded by the system. In some embodiments, this process is applied to all valid organization names, variations of names and/or erroneous entries of names. In some embodiments, the system is configured to execute editing and standardization rules to each name.

In some embodiments, the system is configured to record ancillary identification data. In some embodiments, the system is configured to relate one or more (e.g., every) names, addresses, organizations, and/or ancillary data to one or more (e.g., any) identifier. In some embodiments, the system is configured to enable a user to ask for all relationships an individual may have and/or can ask which individuals are related to an organization, and address or any other identifier. In some embodiments, the system is configured to determine one or more (e.g., all) family members and/or relatives related to an individual. In some embodiments, all relationship unique universal identifications (UUIDs) are bidirectional allowing for a very fast qualification of relationships as compared to conventional database search engines.

In some embodiments, the system is configured to generate an identification table. In some embodiments, the identification table includes one or more of a unique identity table, an individual preferred name table, a healthcare provider table, a standardized names table, an address table, an ancillary identification table, and/or an entities table which are stored in non-transitory memory. In some embodiments, the unique identity table comprises attributes that uniquely resolve the identity of every record. In some embodiments, the system is configured to created and store the unique identity table when the master database is built. In some embodiments, the individual preferred name table includes preferred individual names and/or recent (e.g., less than 3 years) high-encounter (e.g., more than 3 instances) name variations. In some embodiments, the healthcare provider table includes one or more healthcare providers and/or an associated National Provider Identifier Number (NPI). In some embodiments, the standardized names table includes one or more standardized names, original entry names, variations, and/or errata. In some embodiments, the address table includes addresses and/or the address verifier. In some embodiments, the ancillary identification table includes ancillary identification data, which include multiple (e.g., 400+) data elements for individuals. In some embodiments, the entities table includes one or more entity organizations, partnerships, LLCs, group affiliations and/or name variations, locations, services, products, employee count, officers, revenue, credit rating and multiple (e.g., 100+) other data elements.

In some embodiments, the system is configured to execute a deterministic identification process. In some embodiments, once the database structure has been built and indexed, a unique identity table is built and contains just the data attributes that make every record unique. In some embodiments, the system is configured to process millions of records per hour.

In some embodiments, the system is configured to execute and intake process. Some embodiments comprise a step to apply incoming record validation, client requirements, and/or billing. Some embodiments comprise a step to map the record to a vector. Some embodiments comprise a step of executing an identification process using the unique identity table. In some embodiments, if matched, a step includes to retrieve related data from the master database. In some embodiments, if the unique ID table match fails, then a detailed match process is executed and applied to the master ID database.

In some embodiments, e.g., to handle very high volumes, the system is configured to execute distributed microservices (e.g., cloud services) to execute one or more steps described herein (e.g., first four steps above). In some embodiments, a high percentage of the records can be identified in 4 to 5 milliseconds using the unique identity microservice and as many micro services can be invoked as necessary to meet service-level requirements.

In some embodiments, the system is configured to execute an extended matching process. In some embodiments, if the unique identity match process fails, the names vector invokes the extended match processes. Some embodiments comprise a step of the system attempting to match the submitted name to a primary names table loaded in memory. Some embodiments comprise a step of attempting a match using the standardized names and variations table. Some embodiments comprise a step of using the address table to attempt a match. Some embodiments comprise a step of using the ancillary data to attempt a match. Some embodiments comprise a step of attempting a match using data from external licensed databases. Some embodiments comprise a step of implementing Artificial intelligence (AI) processes described herein. In some embodiments, a reference to AI includes one or more of neural networks, machine learning, deep learning, computer vision, natural language processing, and the like. In some embodiments, if all automation fails, a manual process is initiated which is then stored in the errata.

In some embodiments, with the combination of in-memory processing and related lookup tables, the average response time for a round trip inquiry to a server and back is 50 milliseconds, a standard requirement for online services, but not achievable with the prior art. In some embodiments, multiple front-end servers can be invoked for managing peak loads, each of which can invoke microservices.

In some embodiments, the system includes an AI module configured to execute a deterministic AI system that includes one or more computer executed steps described herein. In some embodiments, the deterministic AI system incorporates determinant identification methodology integrated with an artificial intelligence (AI) system that generates an AI result linked to validating data.

In some embodiments, a step includes generating a determinant database of 225 million plus of unique, US adults associated with age, gender, addresses, phone, ancillary data, individual and entity relationships mapped over time. In some embodiments, variations, errata and changes to names and addresses, employment, etc. create a database with hundreds of billions of data points.

In some embodiments, the determinant database is used to train an artificial intelligence (e.g., Machine Learning/Neural Network) system (AI).

In some embodiments, AI results and insights are used by the AI module to resolve unidentified or misidentified individuals in the original data and adjust the algorithms temperature. In some embodiments, erroneous AI results that the AI discovers are fed back to the AI module for enhanced learning. In some embodiments, the feedback is not in a relearning phase, but in a learning update mode to modify resulting rankings. In some embodiments, confirmed findings by the AI system are incorporated into the determinant database. In some embodiments, the AI integrated systems continually provide mutual feedback that improves the results of the shared database. In some embodiments, AI results are linked to confirmation data.

In some embodiments, the AI is configured to access the deterministic (master) database and learn the identification process from the data and/or derives identification algorithms. In some embodiments, as identification requests are submitted to the deterministic/AI system, the AI is configured to generate a finding and submit the finding to the deterministic process which affirms the AI finding or returns the correct identification. In some embodiments, the AI system is continually being educated by the deterministic system which retains the supporting decision information for the AI finding. This Deterministic/AI integrated system offers the intuitive speed of AI aligned with deterministic system that corroborates results.

In a non-limiting example, the system includes a search module configured to search one or more documents for an instance of a name. In some embodiments, the one or more documents are obtained and/or accessed from the internet. In some embodiments, the AI is configured to associate characteristics of where the name was located with the name itself. In some embodiments, characteristics may include name of a website associated with the name, metadata associated with documentation that includes the name, location where the name was input, time the name was generated, and/or any metadata associated with digital files (e.g., documents, images, audio, etc.).

In some embodiments, the AI module is configured to send the located name to the deterministic module, which includes the vectorization as previously described, for verification using the data stored in the deterministic database. In some embodiments, if the AI module is configured to compare the information in the deterministic database. In some embodiments, if there is a match to the name, the AI is configured to execute one or more vectorization steps previously described for the information associated with the name. In some embodiments, the vectorized information is then assigned one or more unique IDs and/or associated with a deterministic master ID in the deterministic system. In some embodiments, if an error occurs, the system is configured to alert a user to a non-match and/or not add the information to the deterministic database.

In some embodiments, an example where an error may occur is a conflict with time and/or location. In some embodiments, if the AI finds a name in a website database that matches a name in the deterministic database, but the metadata includes location data (e.g., California, Mar. 24, 2020) for one or more dates that does not match known metadata for the individual (e.g., same day, New York), the AI is configured to present this as a non-match. In some embodiments, the system is configured to generate a log of matched and/or unmatched names for an individual search using AI.

However, in some embodiments, the AI is configured to identify a pattern in one or more documents that indicate if an individual is moving. In some embodiments, this enables the system to generate a history of an individual, even if different name variations were used at different times. In some embodiments, the system is configured to vectorize and/or add the name variations that include a high association confidence to the vectorization system. In some embodiments, the vectorization and storage of this data in the deterministic module enables vast amounts of data to be stored and/or more efficiently that prior art databases, enabling a deterministic profile that includes multiple name variations to be built by first seeding the AI with known name variation training data.

In some embodiments, the AI identification process has many applications. In some embodiments, the AI identification process automates the identification process as previously described. In some embodiments, using the deterministic database to train the AI for name recognition results in a superior AI model because there is 100% verified proof of matches for all names and/or data associated with the names. Therefore, the AI model is configured to use the deterministic database (library) as a reference for validity (confidence) checks. In some embodiments, AI document search results (e.g., a web search) are matched to the deterministic database for confirmation and/or used as feedback to validate AI results. In some embodiments, the system is configured to enable discrepancies to be fed back to the AI system to further enhance accuracy. In some embodiments, the combination of the two systems retains all data used in the identification process and/or uses the AI technology to enhance the match results and eliminates the expensive manual processes.

In some embodiments, the identification system (the “system”) is suited for healthcare applications. In some embodiments, the system enables health plan eligibility resolution and or entity billing resolution by confirming an individual's identity. In some embodiments, the system is configured to implement provider network management including determining the current name and affiliation of healthcare providers. In some embodiments, the system includes multiple updates (e.g., 15 years of monthly updates) from the Centers of Medicare Services which maintains the database of National Provider Identifier numbers. In some embodiments, the system is configured to uniquely match a provider's residence location to the practice locations to determine if a provider has moved and ensure the work-home pairing is trustworthy.

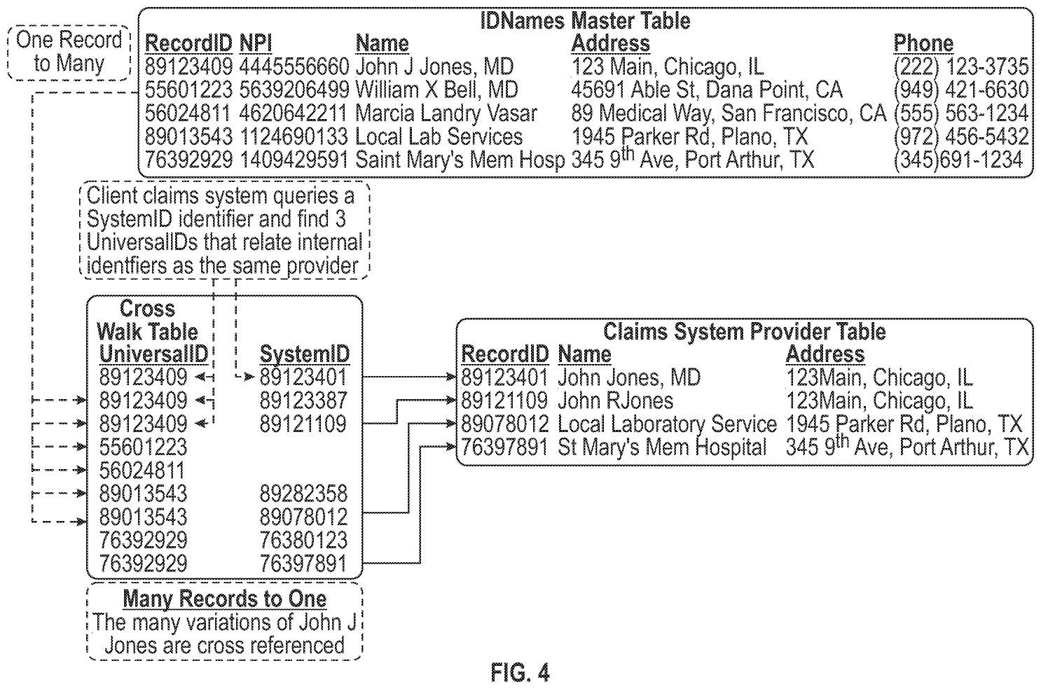

In some embodiments, the system is configured to match a healthcare claim to a provider based on one or more of claim history, location, affiliation, and specialty flag, claims errors. In some embodiments, the system is configured to determine the attending provider if it's missing from the claim. In some embodiments, the identification system can be trained on patient data to verify claims data matched to the correct entity and to identify fraud, waste, abuse, drug adherence, as well as alternate treatments and behavioral health triage. In some embodiments, large health plans and insurers may have multiple administrative systems that don't maintain a common eligibility and provider databases. In some embodiments, the system is configured to generate a crosswalk reference table that configured to enable the system to identify individual patients and providers among multiple claims systems. FIG. 4 depicts a crosswalk table execution map according to some embodiments.

In some embodiments, the system includes a high percentage of US adults with unique identifying characteristics that include one or more or addresses by location (e.g., latitude and/or longitude to the rooftop level), entity relationships such as employers, personal profiles, etc. In some embodiments, the system includes many other data sets such as health data for individuals, environmental data of geographic areas, census data to the block level, financial data for local geographic areas, disease statistics, etc. In some embodiments, any data that focuses on people, places, related entities, etc. can be added to the system.

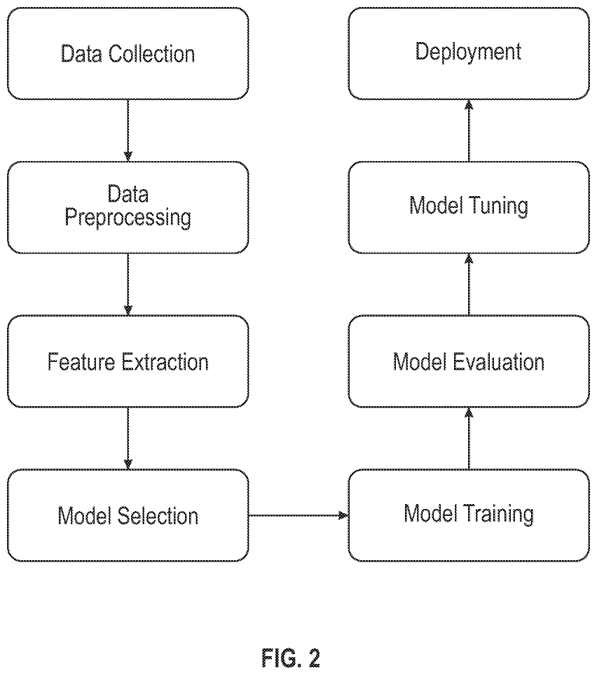

FIG. 2 illustrates a flowchart for building an AI model according to the systems and methods described herein. Some embodiments comprise a first step of data collection. In some embodiments, data collection includes the creation of a training set. In some embodiments, the data set includes the original names used to populate the vectorized database.

Some embodiments comprise a second step that includes data preprocessing. In some embodiments, the data preprocessing step includes the transformation of names into a vector as described herein. Some embodiments comprise a feature extraction step including the removal and/or classification of hyphens, double spaces, etc. as describe herein. In some embodiments, model selection depends on the particular application, and includes the section of one or more neural networks (e.g., logistic regression, SVM, KNN, etc.) to include in the AI model.

Some embodiments comprise a model training step of fitting the best combination of weights and bias to minimize a loss function over a predicted range. Some embodiments comprise a model evaluation step including implementing a document search (e.g., web search) of one or more names as previously described and evaluating the accuracy of the returned name and/or associated data. Some embodiments comprise a model tuning step which includes finding optimal values for one or more hyperparameters to maximize model performance. In some embodiments, hyperparameters includes variables that include values that can't be estimated by the model from the training step. Some embodiments comprise a deployment step including enabling the AI to search for information associated with each name in the vectorized database.

FIG. 1 illustrates a flow chart of a hybrid cloud system according to some embodiments. In some embodiments, the Healthcare Identification Cloud System (HDC; the system) operates in a hybrid cloud environment. In some embodiments, the healthcare data cloud system's application can scale efficiently for rapid growth. In some embodiments, the system uses conventional cloud services (e.g., Microsoft Azure, Amazon Web Services, etc.) In some embodiments, hybrid cloud architecture is designed to incorporate external computers, disk arrays and other cloud environments. In some embodiments, the system can access large troves of healthcare data without migrating to the cloud until usage volume requires a move to the cloud.

FIG. 2 illustrates a flow chart of the system's operations and components according to some embodiments. In some embodiments, the system includes an Identification Mastering Utility (IMU); a Data Mastering Utility (DMU); a Report Designer Management Utility (RDMU); and a Data Interface Designer and Management Utility (DIDMU). In some embodiments, the arrows represent a bi-directional flow of data between each utility.

In some embodiments, the Identification Mastering Utility (IMU) includes tables that store multiple ID variations. In some embodiments, the IMU uses different tables for different ID types. In some embodiments, different ID types are stored in at least one of a Population Table, an Organization Table, and Address Table, and/or a Variations Table. In some embodiments, the system accesses one or more tables, utilities, and or modules described herein intermittently, consecutively, and/or simultaneously (simultaneously as used herein can include lag and or latency times associated with a conventional computer attempting to process multiple types of data at the same time).

In some embodiments, the system includes a Population Table. In some embodiments, the Population Table includes data on individuals in a geographical area. In some embodiments, a Population Table includes data on individuals in a country and/or in multiple countries. In some embodiments, the geographical area is used as an identifier.

In some embodiments, the system includes an Organization Table. In some embodiments, the Organization Table links an individual's data to an agency. In some embodiments, the Organization Table links an individual's data to multiple agencies. In some embodiments, agencies are used as an identifier.

In some embodiments, the system includes an Address Table. In some embodiments, the Address Table links an individual's data to an address. In some embodiments, the Address Table links an individual's data to multiple addresses. In some embodiments, addresses are used as a unique identifier.

In some embodiments, the system includes one or more Variations Tables (a reference to a single Variations Table and/or multiple Variations Tables are collectively referred to as a/the Variations Table herein; a reference to a “table” is a reference to a table other than the Variations Table unless stated otherwise; a reference to a “table” may include any table that is part of the system and/or located in a separate database as described herein). In some embodiments, the Variations Table includes data variations from one or more other tables. In some embodiments, each table has a corresponding Variations Table. In some embodiments, data variation from multiple tables are stored in a single Variations Table. In some embodiments, multiple Variations Tables include data from a single table. In some embodiments, a Variations Table includes any ID variations associated with an individual. As used herein, “table” includes any conventional data presentation format.

In some embodiments, example ID variations include name spellings (including misspellings), addresses, phone numbers or any ID describing an individual, and/or the error associated with the IDs. For example, Table 1 shows a Variations Table including variations of an ID for an individual Mary Jane Smith Jones, MD, according to some embodiments. In some embodiments, each numbered row corresponds to an ID used by one or more organizations. In some embodiments, the bracketed ID in row 1 is a master ID. In some embodiments, all IDs bolded and underlined in the Variations Table refer to the same individual: most ID variations are correctly spelled but the underlined ID variations are errors.

TABLE 1
Variations Table

| No | First | Middle | Last | Degree |
|---|---|---|---|---|
| [1] | [Mary Jane] | | [Smith Jones] | [MD] |
| 2 | Mary | Jane | Smith-Jones | MD |
| 3 | Mary Jane | Smith | Jones | MD, PhD |
| 4 | Mary | | Jones | PA, PhD |
| 5 | Jane | | Smith | MD |
| 6 | Mary | Jones | Smith | |
| 6 | Jayne | | Smith | MD |
| 7 | Mary | Joan | Smyth | |
| 8 | MJ | Smith | Jones-Smith | PhD, MBA |
| 9 | MJ | | Smith | |

The IMU accumulates variations in IDs (e.g., names, addresses, titles, degrees, phone numbers, labels, personal attributes, organizational relationships and any other data elements from one or more agencies) and stores them in the Variations Table according to some embodiments. In some embodiments, the ID variations are ranked and labeled by frequency, accuracy, date entered, and ID currently used. In some embodiments, the highest ranked ID is labeled as a master ID. In some embodiments, one or more records associated with each ID variation is also associated with the master ID. In some embodiments, entry of any ID variation from the Variations Table causes the system to form links to data associated with the master ID (e.g., hospital records, criminal records, etc.).

In some embodiments, each ID includes one or more data elements. In some embodiments, example data elements are shown in Table 3.

TABLE 3
Example Data Elements
Data Elements

| 1. | HDCS_PERSONAL_ID |
|---|---|
| 2. | TELEPHONE NUMBER |
| 3. | TIME ZONE PHONE |
| 4. | MOBILE NUMBER |
| 5. | GENDER CODE |
| 6. | DOB_YR |
| 7. | DOB_MO |
| 8. | DOB_DY |
| 9. | AGE CALCULATED |
| 10. | AGE ESTIMATED |
| 11. | INCOME-ESTIMATED HOUSEHOLD |
| 12. | NET WORTH |
| 13. | EDUCATION |
| 14. | OCCUPATION |
| 15. | BUSINESS OWNER |
| 16. | NUMBER OF CHILDREN |
| 17. | PRESENCE OF CHILDREN |
| 18. | MARITAL STATUS IN THE HHLD |
| 19. | HOME OWNER or RENTER |
| 20. | LENGTH OF RESIDENCE |
| 21. | DWELLING TYPE |
| 22. | NUMBER OF ADULTS |
| 23. | HOUSEHOLD COUNT |
| 24. | HOME MARKET VALUE |
| Address Data Elements | |
| 1. | HDCS_ADDRESS_ID |
| 2. | ADDRESS |
| 3. | ADDRESS_NO |
| 4. | ADDRESS_ST_NAME |
| 5. | ADDRESS_ST_TYPE |
| 6. | ADDRESS_VANITY |
| 7. | SUITE OR APT |
| 8. | CITY |
| 9. | STATE |
| 10. | ZIP5 |
| 11. | ZIP4 |
| 12. | DELIVERY POINT BAR CODE |
| 13. | CARRIER ROUTE |
| 14. | FIPS STATE CODE |
| 15. | FIPS COUNTY CODE |
| 16. | LATITUDE-rooftop level |
| 17. | LONGITUDE-rooftop level |
| 18. | ADDRESS TYPE INDICATOR |
| 19. | MSA CODE |
| 20. | CBSA CODE |
| 21. | ADDRESS LINE |
| 22. | CENSUS TRACT |
| 23. | CENSUS BLOCK GROUP |
| 24. | CENSUS BLOCK |
| 25. | CENSUS MEDIAN HOME VALUE |
| 26. | CENSUS MEDIAN HOUSEHOLD INCOME |
| 27. | TELEPHONE PRESENT FLAG |
| 28. | TELEPHONE NUMBER |
| 29. | TIME ZONE |

In some embodiments, the IMU includes a Name Parsing Module (NPM). In some embodiments, the NPM parses an ID from rows in one or more tables (e.g., the Variations Table) into one or more columns using an ID vector (IDV; also called a name vector). In some embodiments, instead of a name being stored in data fields such as First, Middle, Last names, names are stored in a name vector where names, spaces, and hyphens associated with an ID are stored with notation of the order. In some embodiments, matching logic is applied to the vector comparing it to all similar names in the Variations table and finding all possible matches. In some embodiments, additional data is then used to resolve the matches to one or a few choices. In some embodiments, the ID vector adds common and/or defined ID variations (e.g., names, spaces, hyphens, surname order, language-specific spellings, known misspellings, and/or punctuations) automatically to each ID and/or data element entered into the system as an ID iteration in one or more Variations Tables (e.g., a row in Table 1) and/or other tables.

In some embodiments, the system is configured to apply name match logic. In some embodiments, name match logic includes the application of a set a set of rules that utilizes the variations tables for individual names and organizations, addresses and IDs. In some embodiments, the logic table is derived by utilizing artificial intelligence routines to create 300 plus rules that utilize the tables which creates logical choices used to match names, organizations, addresses, claims, medical reports, etc. In some embodiments, NPM accesses one or more tables and applies the NMS steps described below.

TABLE 2
Name Matching Sequence
Name Match Sequence (NMS)

| | |
|---|---|
| 1. | Parse ID using ID vector |
| 2. | Match parsed ID to master ID |
| 3. | Match parsed ID to alternative names |
| 4. | Apply name match logic. |
| 5. | Apply Artificial Intelligence (Al) |
| 6. | Accesses name finder web sites and match logic |
| 7. | Accesses 1 to 3 of the retail credit agencies and match logic |
| 8. | Collect IDs found on the web and found by phone calls and/or |
| | other communications and record those IDs along with ID |
| | manual edits in the Variations Table |
| 9. | Apply Artificial Intelligence (Al) again |

For example, with reference to Table 1, in some embodiments, a primary name shown is Mary Jane Smith Jones. However, the name Mary Jane Smith Jones could appear in the Variations Table in any combination according to some embodiments. In some embodiments, the NPM can loop through the Name Match Sequence several times and apply some or all combination of IDs and/or data elements in each row to get a table that includes columns representing each ID and/or data element component (e.g., first name, last name, address, etc). In some embodiments, the system uses artificial intelligence (AI) to determine each ID and/or data element component data type. In some embodiments, each ID and/or data element component type is listed under a different field.

In some embodiments, the system includes a Data Editing, Proper Casing and Enrichment Module (DEPCEM) configured to be used by the IDM. In some embodiments, the DEPCEM is configured to create and incorporate edit tables. In some embodiments, the DEPCEM is configured to standardize data so that identification matches and statistical analyses function properly. In some embodiments, the DEPCEM includes tables such as titles, degrees and suffix (Jr, II, III, IV), Scottish names, proper casing and the like, ensure a standard approach to spelling. In some embodiments, the DEPCEM includes tables that include abbreviations such as degrees (i.e., PhD, MA, DO, MD), (Jr, III, IV), numbers and math symbols, proper formats for currencies, numbers formatting, and data standardization software. In some embodiments, the DEPCEM is configured to fill in missing data-dictionary entries based on a set of user or administrator defined rules. In some embodiments, the DEPCEM is configured to be editable to help ensure that names are properly identified and matched.

In some embodiments, the system uses the ID iterations to search for an individual's data and/or records across one or more organizations. In some embodiments, ID iterations are automatically associated with the master ID. In some embodiments, searching and or entering an ID that matches an ID iteration also returns all data associated with the master ID.

In some embodiments, the system includes one or more tables for one or more individual types. In some embodiments, the system includes a Population Table. In some embodiments, the Population Table includes names, records, and/or data elements of people residing and/or who have resided in the United States and/or any foreign country. In some embodiments, the Population Table holds over 300 million individual records of the 330+ million total records in the United States. In some embodiments, the system is configured to be scalable to hold all records worldwide. In some embodiments, the Population Table can maintain one or more of the following data for each person: name, name variations (as created by the IMU); addresses, address variations (e.g., with 29 or more or fewer data elements for each address); personal data (e.g., with 20 or more or fewer data elements); retail credit and purchasing preferences (e.g., with 150 data elements); and/or ancillary data obtained from the internet. In some embodiments, a Population Table can include and/or link to one or more Variations Tables that includes ID and/or variations for each individual.

In some embodiments, the system includes an Organizations Table. In some embodiments, the Organizations Table holds the names, records, and/or data elements associated with one or more organizations (i.e., agencies). In some embodiments, the Organizations Table can hold over 20 million master records. In some embodiments, individuals can be linked to organizations. In some embodiments, organizations can include one or more of the following: companies, partnerships, social societies, practices, health plans, groups of individuals, clubs, associations and/or any type or agency. Some embodiments can include any number of data elements (e.g., addresses, telephone numbers, related individuals, organization health plans, related organizations, descriptive codes, services, web links, and/or anything that is associated with an individual that can be described in writing and/or digitally). In some embodiments, there are approximately 60 data elements for organizations. In some embodiments, organizations can be related to other organizations using artificial intelligence and/or statistical analyses techniques.

In some embodiments, the system includes an Organization Abbreviation Table. In some embodiments, organizations (i.e., agencies) present a more complex identification problem because they contain name variations and abbreviations. In some embodiments, an Organization Abbreviation Table can provide additional name variations. In some embodiments, the Organization Abbreviation Table can provide more data points such as multiple addresses, provider affiliations, organizations members, group affiliations, and the like. In some embodiments, the Organization Abbreviation Table can be utilized to accurately and precisely identify an organization.

Some embodiments of the system comprise an Address Table. In some embodiments, the Address Table holds the names, records, and/or data elements associated with one or more Addresses. In some embodiments, the Address Table can hold over 135 million master records. In some embodiments, one or more Variations Tables are configured to store the variations and/or the source of the variations. In some embodiments, one or more Variations Tables include one or more address data elements.

Some embodiments include a Dynamic Schema Table. In some embodiments, the Dynamic Schema Table can include extensible attributes. In some embodiments, a Data Interface and Management Utility and Report Designer is configured to use one or more Dynamic Schema Table definitions to determine how to format a field in a report.

TABLE 4
Dynamic Schema Table

| Function | Field Attributes | Use | Example | Alternatives |
|---|---|---|---|---|
| Variable | Field Name | Alternative Field Names | Provider | Provider |
| | (Identifiers) | are retained | Network | Network Name |
| | | | Name | (this is a table of |
| | | | | alternative names) |
| Variable | Data Source | Data Source stores Field | Net Table | Prov_Net_Name |
| | | Name label alternatives | 10045A | |
| Variable | Data Type | Programmer definition | Text | Prov Net |
| Field Def | Field Size | Programmer definition | 50 | Prov Net Nm |
| Field Def | Input Mask | System function | | PNM |
| Value | Default Value | Used if no value found in | | Network Name |
| Def | | incoming data | | |
| Value | Unit Measure | i.e., Source in Meters; | | Net Nm |
| Def | | Euros; Celsius | | |
| Value | Unit | Converts to Feet; Dollars; | | |
| Def | Conversion | Fahrenheit | | |
| Value | Converted | Converted value; system | | |
| Def | Value | retains sample of data | | |
| | | and creates a reference | | |
| | | profile | | |
| Value | Validation Rule | Applied rules make sure | | |
| Def | | values entered are valid | | |
| Value | Required | User left blank | M or F is | |
| Def | | | required | |
| Value | Allow Zero | No entry required | | |
| Def | Length | | | |
| Index | Indexed | System function | Yes | |
| Report | Minimum Value | User entered 3 | 5 | |
| Report | Maximum | User entered 50 | 20 | |
| | Value | | | |
| Report | Unit of | i.e. Feet or Meters | | |
| | Measure | | | |
| Report | Col Data Value | | | |
| Report | Report Col | User entered | Prov Nt Nm | |
| | Label Short | | | |
| Report | Report Col | User entered | Prov Net | |
| | Label Long | | Name | |
| Report | Column Width | Programmer definition | 30 | |
| Report | Default Sort | Programmer definition | Alpha A-Z | |

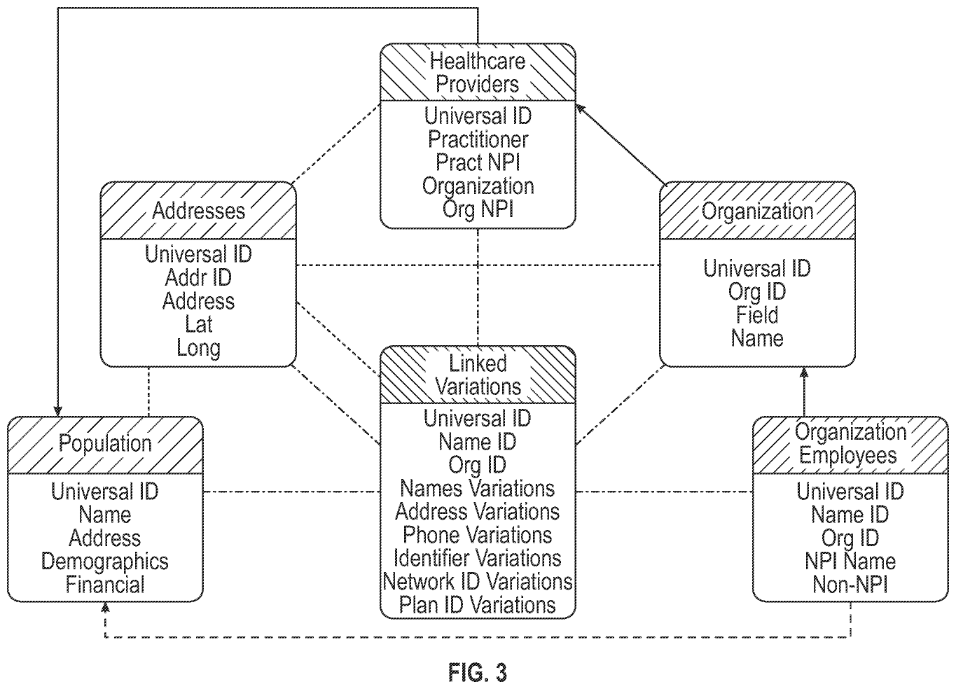

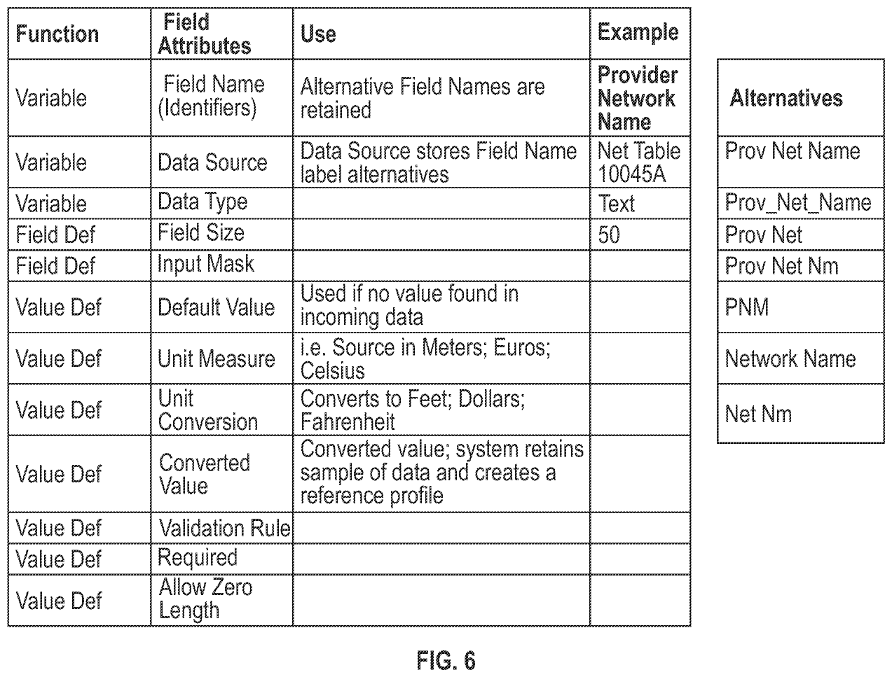

Some embodiments include a Data Interface and Management Utility (DIMU). In some embodiments, the DIMU can record field identifiers from any data source and map them to the master identifiers. FIG. 3 illustrates a logic execution map according to some embodiments. In some embodiments, the DIMU can scan a healthcare data file. In some embodiments, the DIMU can attempt to define the data elements and create a schema (e.g., a Dynamic Schema Table) including field labels. FIG. 6 illustrates a dynamic schema table model according to some embodiments. In some embodiments, any unresolved field can be resolved manually. In some embodiments, the system can remember the edit definitions for the data source and can check for changes or errors in the data for all future loads.

In some embodiments, the system can automatically build a crosswalk table. In some embodiments, the crosswalk table is configured to automatically update changes to data (i.e. the system remembers (i.e., stores, accesses, and retrieves) a client's administrative system's tables of providers and member eligibility and can automatically update the client records (and one or more tables) when a change is recorded in the system.

In some embodiments, the DIMU can include data definition templates. In some embodiments, the data definition templates can be included for one or more of: provider networks, claims tables for medical, laboratory, hospital, eligibility, dental and electronic medical records in key systems. In some embodiments, one or more templates can be altered and saved as a new template.

Some embodiments include a Data Mastering Utility (DMU). In some embodiments, the DMU can describe any data element. In some embodiments, the data element is in one or more databases, tables and/or programs. Some embodiments include schema, such as field name or variable name, format, data type, size and other database attributes. In some embodiments, one or more field labels from any data source can be linked to the system field name. In some embodiments, data translation attributes can be specified between a data source and the healthcare data cloud system. In some embodiments, translation attributes allow data conversion to be applied automatically (i.e. meters to feet, kilograms to pounds, and the like, as a non-limiting example).

Some embodiments include a Report Designer and Report Manager Utility (RDMU). In some embodiments, the RDMU is configured to allow users to drag-and-drop data elements defined in the DMU. In some embodiments, the schema for a data element contains a column width and column label. In some embodiments, the columns are distributed across a page and/or automatically formatted for portrait or landscape formats. In some embodiments, column totals and averages can be specified for each column. In some embodiments, running averages and other computational columns can be inserted along with titles and explanatory text, dates and times.

In some embodiments, the RDMU can include report templates. In some embodiments, the report templates can be used for one or more record of a database (e.g., provider networks, medical facilities, laboratories, hospitals, and dentist). In some embodiments, one or more templates are configured to be altered and saved as a new template. In some embodiments, the RDMU is configured to schedule report frequency and/or distribution.

The system includes a Provider Network Management System (PNMS) in some embodiments. In some embodiments, providers are mapped to any number of provider networks. In some embodiments, provider networks are defined by state and county or city. In some embodiments, subcontracted networks are defined to extend geographic coverage. In some embodiments, wrap around networks, out of area networks and specialty networks are defined and linked to a health plan. In some embodiments, the PNMS is configured to create networks. In some embodiments, the created networks are based on geography, specialty and subspecialty. In some embodiments, PNMS is configured to create model networks that are tested against patient distribution and coverage for each patient by specialty. In some embodiments, the PNMS is configured to model financial performance when data is available.

In some embodiments, the PNMS is configured to define a model network. In some embodiments, the model network is comprised of any number of contracted PPO networks by using states or counties to specify the geographic area covered by each network. In some embodiments, the model network is refined by provider category (i.e., medical, dental, vision, ancillary, and the like) and/or specialty (i.e., primary care, orthopedic, psychiatric, and the like). In some embodiments, individual facilities and/or physicians are included or excluded from a model network to meet exact provider network requirements.

In some embodiments, the PNMS includes a method of use that includes one or more of the following steps: define a model network to meet the requirements and needs of any organization or health plan; find doctors or hospitals contracted by their health plan by using a provider finder web site that accesses the specific provider network assigned to their health plan; automatically transmit a provider network data set to each payer client for use in the claims system of a provider network; access a payer client claims system plan's specific network through a web service to get up-to-date validation of provider network status; use a web service for a payer client to “identify” the provider in a claim and obtain up-to-date demographic and billing information; and/or use a web service to determine if a provider is in or out of network on a specific date.

Some embodiments can include a Provider Specialty Management Module (PSMM). In some embodiments, the specialty manager table can incorporate cross-reference technology. In some embodiments, the cross-reference technology is configured to automatically create one or more provider types, specialties, and/or subspecialty categories for any client, in any country, and/or in any common languages. In some embodiments, cross-reference technology includes the system being configured to use the specialty (and/or specialties) claimed by the healthcare provider are matched to actual diagnoses, procedures and prescriptions issued by the provider to determine if the provider's practice patterns support the claimed specialties.

Some embodiments include a Health Insurance Portability and Accountability Act (HIPAA) compliance module. In some embodiments, the HIPAA compliance module is configured to identify a patient, validate the provider's right to review the patient's medical records, and/or record that the provider did attest to the patient signing the HIPAA release. In some embodiments, the system is configured to store a copy of the patient release. In some embodiments, the HIPAA compliance module is configured to allow a provider to upload documents including the HIPAA release. In some embodiments, the system is configured to text the patient's phone and obtain a text confirmation of the patient's agreement to release the healthcare records to the provider.

Some embodiments of the system include a Data Security and Encryption Module (DSEM). In some embodiments, all HIPAA data is retained in separate, secure data areas and related to each of the system modules through encrypted keys. In some embodiments, key identifiers are encrypted and retained in secure data areas. In some embodiments, user logins are managed through a system identifier that utilizes numerous data elements to identify users and their compliance with HIPAA rules.

As shown in FIG. 4, in some embodiments the system (i.e., the Healthcare Identification Cloud System; HDC) supports a market that includes a vast array of organizations that are designing, underwriting and offering health plan models. In some embodiments, organizations which offer patient medical services also administer, audit and analyze claims. In some embodiments, the system provides a web-based service to all healthcare organizations to correlate identifiers, data elements, and/or records associated with an individual a single global HDC identifier. In some embodiments, approximately 250+ million people are covered by health plans, but everyone uses the healthcare system and almost all are subsidized. FIG. 4 shows many types of healthcare provider and support organizations that maintain their own patient and plan-member identifiers. In some embodiments, the system is configured to create a data model for each type of healthcare organization represented in FIG. 4.

In some embodiments, the healthcare data cloud services market depicted in FIG. 4 is shown as an active web page in the system. In some embodiments, each organization type such as individuals, organizations, insurers, HMO's, medical groups, reinsurers, provider networks, etc. require different types of information for operations and decision-making purposes. In some embodiments, by clicking on an organization type on the market web page the user defines the data requirements for accepting data from and delivering data to that organization. Also, in some embodiments, the organization variations table includes retention models for deriving profitability, utilization, patient mix, high-risk patients and many other factors important to the business of healthcare stored with the organization's profile. In some embodiments, the system is configured to manage the data communications between a physician specialty group and an insurance plan administrator just by clicking on the diagram location for both organizations in the active web page depicted in FIG. 4.

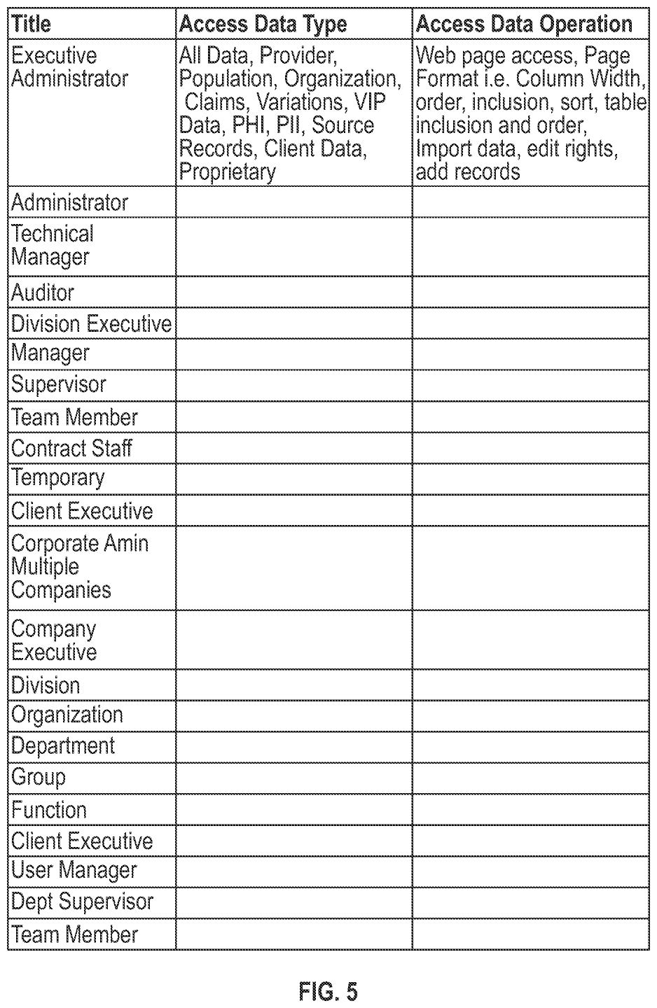

FIG. 5 illustrates a computer server system network 1830 of the system's content control server system architecture according to some embodiments of the invention. In some embodiments, the computer server system network 1830 comprises a computer server system 1830 configured for operating and processing components of the content control server system architecture 10 in accordance with some embodiments of the invention. In some embodiments, the computer system 1830 is configured to process one or more software modules of the aforementioned content control system and method applications and is configured to display information related to user content within one or more graphical user interfaces. In some embodiments, the server system 1830 is configured to comprise at least one computing device including at least one processor 1832. In some embodiments, the at least one processor 1832 is configured to include a processor residing in or coupled to one or more server platforms. In some embodiments, the server system 1830 is configured to include a network interface 1835a and an application interface 1835b coupled to the least one processor 1832 is configured to be capable of processing at least one operating system 1840. Further, in some embodiments, the interfaces 1835a, 1835b coupled to at least one processor 1832 can be configured to process one or more of the software modules (e.g., such as enterprise applications 1838). In some embodiments, the software modules 1838 can include server-based software that is configured to include content control software modules such as a content engine. In some embodiments, the software modules 1838 is configured to operate to host at least one user account and/or at least one client account and operate to transfer data between one or more of these accounts using the at least one processor 1832, and process any operation of the content control server system architecture 10 described herein.

With the above embodiments in mind, it should be understood that the invention can employ various computer-implemented operations involving content control data stored in computer systems according to some embodiments. Moreover, in some embodiments, the above-described databases and models throughout the content control can store analytical models and other data on computer-readable storage media within the server system 1830 and on computer-readable storage media coupled to the server system 1830. In addition, in some embodiments, the above-described applications of the content control system 10 can be stored on computer-readable storage media within the server system 1830 and on computer-readable storage media coupled to the server system 1830. In some embodiments, these operations are those requiring physical manipulation of physical quantities. ‘Usually, though not necessarily, in some embodiments these quantities take the form of electrical, electromagnetic, or magnetic signals, optical or magneto-optical form capable of being stored, transferred, combined, compared and otherwise manipulated. In some embodiments, the server system 1830 is configured to comprise at least one computer readable medium 1836 coupled to at least one data source 1837a, and/or at least one data storage device 1837b, and/or at least one input/output device 1837c. In some embodiments, the invention is configured to be embodied as computer readable code on a computer readable medium 1836. In some embodiments, the computer readable medium 1836 is configured to be any data storage device that can store data, which can thereafter be read by a computer system (such as the server system 1830). In some embodiments, the computer readable medium 1836 is configured to be any physical or material medium that can be used to tangibly store the desired information or data or instructions and which can be accessed by a computer or processor 1832. In some embodiments, the computer readable medium 1836 is configured to include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 1836 is configured to transmit or carry instructions to a computer 1840 and/or at least one user 1831, including a router, private or public network, or other transmission device or channel, both wired and/or wireless. In some embodiments, the software modules 1838 is configured to send and receive data from a database (e.g., from a computer readable medium 1836 including data sources 1837a and data storage 1837b that can comprise a database), and data can be received by the software modules 1838 from at least one other source. In some embodiments, at least one of the software modules 1838 is configured to output data to at least one user 1831 via at least one graphical user interface rendered on at least one digital display.

In some embodiments, the computer readable medium 1836 is configured to be distributed over a conventional computer network via the network interface 1835a where the content control system 10 embodied by the computer readable code can be stored and executed in a distributed fashion. For example, in some embodiments, one or more components of the server system 1830 are configured to be coupled to send and/or receive data through a local area network (“LAN”) 1839a and/or an Internet coupled network 1839b (e.g., such as a wireless Internet). In some embodiments, the networks 1839a, 1839b are configured to include wide area networks (“WAN”), direct connections (e.g., through a universal serial bus port), or other forms of computer-readable media 1836, and/or any combination thereof.

In some embodiments, components of the networks 1839a, 1839b are configured to include any number of user devices such as personal computers including for example desktop computers, and/or laptop computers, or any fixed, generally non-mobile Internet appliances coupled through the LAN 1839a. For example, some embodiments include personal computers 1840a coupled through the LAN 1839a that are configured for any type of user including an administrator. Some embodiments include personal computers coupled through network 1839b. In some embodiments, one or more components of the server system 1830 are configured to send or receive data through an Internet network (e.g., such as network 1839b). For example, some embodiments include at least one user 1831 coupled wirelessly and accessing one or more software modules of the content control system 10 including at least one enterprise application 1838 via an input and output (“I/O”) device 1837c. In some embodiments, the server system 1830 can enable at least one user 1831 to be coupled to access enterprise applications 1838 via an I/O device 1837c through LAN 1839a. In some embodiments, the user 1831 is configured to comprise a user 1831a coupled to the server system 1830 using a desktop computer, and/or laptop computers, or any fixed, generally non-mobile Internet appliances coupled through the Internet 1839b. In some embodiments, the user 1831 can comprise a mobile user 1831b coupled to the server system 1830. In some embodiments, the user 1831b can use any mobile computing device 1831c to wireless coupled to the server system 1830, including, but not limited to, personal digital assistants, and/or cellular phones, mobile phones, or smart phones, and/or pagers, and/or digital tablets, and/or fixed or mobile Internet appliances.

In some embodiments, the server system 1830 is configured to enable one or more users 1831 coupled to receive, analyze, input, modify, create and send data to and from the server system 1830, including to and from one or more enterprise applications 1838 running on the server system 1830. In some embodiments, at least one software application 1838 running on one or more processors 1832 is configured to be coupled for communication over networks 1839a, 1839b through the Internet 1839b. In some embodiments, one or more wired or wirelessly coupled components of the network 1839a, 1839b is configured to include one or more resources for data storage. For example, in some embodiments, this can include any other form of computer readable media in addition to the computer readable media 1836 for storing information and can include any form of computer readable media for communicating information from one electronic device to another electronic device.

FIG. 6 illustrates another flow chart of the system's operations and components according to some embodiments. In some embodiments, the system includes a Data Interference and Management Utility; a Data Mastering Utility; an Identification Mastering Utility; External Data collected from one or more external databases; Identification Logic; an Individual Name Variations Table; and Organization Name Variations Table; an Identifiers Table; an Address Variations Table; and/or a Natural Language Variations table. In some embodiments, the arrows represent a bi-directional flow of data between each utility.

In some embodiments, The Healthcare Identification Cloud System (HDCS: the “system”) addresses a major problem in healthcare: the unique identity of people, patients, healthcare providers, organizations, family relationships, employment relationships, provider network relationships, health plan identities and relationships to all related parties. In some embodiments, unique identities are required for assigning symptoms, diagnoses, prescriptions, procedures, reimbursement for services, claims, eligibility and endless other processes and administrative requirements.

In some embodiments, the system is configured to uniquely identify one or more of individuals, organizations, and healthcare providers based upon one or more (e.g., billions of) attributes. In some embodiments, the system is configured to return the information in less than 50 milliseconds. In some embodiments, the system includes a cloud environment. In some embodiments, the system is configured to determine a required amount of computer resources to return the information in less than 50 milliseconds. In some embodiments, the system is configured to automatically initiate additional servers to process one or more records to return the results in less than 50 milliseconds. In some embodiments, the identification process is 100% deterministic, not probabilistic, and/or incorporates proprietary matching logic and artificial intelligence solutions. In some embodiments, the system is configured to be integrated and/or optimized in a distributed, hybrid cloud environment.

In some embodiments, the system is configured is configured to interface with one or more databases. In some embodiments, the one or more databases include databases for one or more of people, organizations, locations, payers, and/or thousands of attributes. In some embodiments, one or more databases include a population database configured to enable the system to uniquely identify (e.g., 300 million-plus) individual people as well as each person's (e.g., 400-plus) attributes and/or related health history.

In some embodiments, the system includes an organization database that is configured to enable the system to uniquely identify (e.g., 20 million-plus) public, private, social, industry, and/or governmental organizations each with (e.g., 300-plus) associated attributes. In some embodiments, the system is configured to track related individuals via the organization database.

In some embodiments, the system includes an address database for one or more countries (e.g., the United States) or regions or other desired geographic boundaries or criteria. In some embodiments, the address database includes one or more (e.g., 150 million-plus) addresses, address misspellings, address latitude and longitude, and/or one or more other conventional geographic descriptions for addresses.

In some embodiments, the system includes one or more learning databases. In some embodiments, each learning database is configured to retain variation information including errata and/or variations of one or more individuals and/or organizations. In some embodiments, the learning database is configured to receive and/or record variations of a name of an individual, entity, organization, address, and/or any defining attributes. In some embodiments, the system includes one or more errata files. In some embodiments, an errata file is configured to store and/or enable access to variation data. In some embodiments, the errata file is configured to be managed by a logic program and/or rules table. In some embodiments, the system is configured to enable one or more individuals, organizations, and/or addresses that cannot be automatically identified by the system to be resolved through interfacing to one or more other data sources (e.g., databases) and/or manually.

In some embodiments, the system is configured to identify and/or store identifying source data for each match to a master ID and/or errata ID in a database. In some embodiments, the source data includes a date and time the match occurred. In some embodiments, the system is configured to store one or more unique identifiers (IDs) for each address for an individual and/or organization, as well as the data source and date according to some embodiments. In some embodiments, rules match logic (i.e., rules match program instructions) is enhanced using one or more other system program logic instructions. In some embodiments, the system is configured to match an individual person's identity (ID) to the professional provider identity.

In some embodiments, one or more program instructions include a step to generate a graphical user interface (e.g., a web user interface) configured to guide a user through a process of finding information and/or answering questions. In some embodiments, the system is configured to adjust the GUI based on the one or more previous inputs from a user. In some embodiments, the system is configured to execute, by the one or more processors, source data maintenance using web services and automated, secure FTP sites to intake, process, edit, refine, and/or load ID data into the HISC and/or output clean client data comprising data linked to the master ID.

In some embodiments, the system includes one or more Data-as-a-Service (DaaS) APIs configured to accept a single entry and/or batch entries configured to identify one or more ID variations that include a person, organization, or healthcare provider (e.g., professional or institution) ID. In some embodiments, the system is configured to return, by the one or more processors, one or more IDs in a pre-determined format. In some embodiments, basic and smart DaaS APIs are invoked to analyze a variety of user inputs for large amounts of data.

In some embodiments, the system includes a GUI (e.g., web portal or other desired interface) configured to display a single-line entry input for a user to find people, organizations, healthcare institutions, and providers. In some embodiments, the single-line includes inputs for defining parameters such as geography, people demographics, disease states, procedures, diagnoses, etc. In some embodiments, the system is configured to enable users to customize and/or display reports. In some embodiments, the system is configured to execute analyses including statistics, sorting, artificial intelligence, and graphic and mapping displays.

In some embodiments, the system is configured to enable a universal ID to be entered in association with one or more patient identifying information IDs. In some embodiments, the system is configured to update one or more databases with a respective variation of an ID type (e.g., St vs Street, Jonathan vs John, ABC Inc. vs ABC Incorporated, etc.)

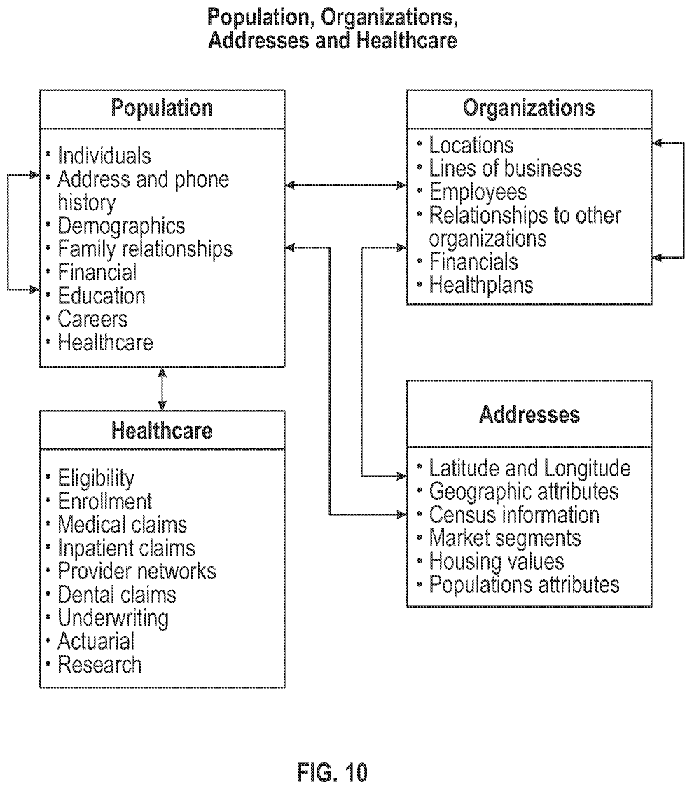

In some embodiments, the system includes an operational service platform, which may also be referred to as an operational web service system herein. In some embodiments, the operational service platform is configured to record, link, match, and/or identify variations of each ID type. Some embodiments comprise a step to link, by one or more processors, healthcare practitioners to personal records. Some embodiments comprise a step to link, by one or more processors, healthcare organizations to business profiles. Some embodiments comprise a step to link, by one or more processors, employees to organizations. Some embodiments comprise a step to link, by one or more processors, addresses that have been verified, geocoded, and/or enhanced from different databases. Some embodiments comprise a step to link, by one or more processors, variations in one or more tables (e.g., every table) in one or more platforms to one or more record IDs (e.g., ID variations) in one or more other platforms (e.g., all record IDs to each other). In some embodiments, the system is configured to generate a GUI (e.g., web user interface or any other desired interface) to access one or more record IDs. In some embodiments, the system is configured to enable healthcare data to be uploaded to the operational service platform and corrected and linked automatically. FIG. 10 shows a flowchart illustrating the link between one or more databases, tables, and/or one or more respective ID parameters.

In some embodiments, a population platform includes a country population (e.g., of US adults) organized by one or more of household dependents, demographic, financial, residence and interest information. In some embodiments, a non-limiting population platform can contain 300 million or more ID records. In some embodiments, an address platform includes one or more address IDs, geographic definitions, rooftop latitude and longitude coordinates, and/or census tract data. In some embodiments, non-limiting example address platforms can include approximately 225 million or more ID records. In some embodiments, a (healthcare or other) provider platform includes CMS (Medicare) or other provider records. In some embodiments, non-limiting provider platforms can include 5 million records and/or 16 years of data. In some embodiments, an organization platform includes one or more business attributes including, but not limited to, products and services, business locations, employees, revenue, credit rating, owners, and officers. In some embodiments, organization platforms can include 25 million or more records.

In some embodiments, the operational service platform includes a Data-as-a-Service (DaaS) is a cloud-based reference service (Operational Web Service) provided through a computer-to-computer network. In some embodiments, the operational service platform is configured to automatically review one or more claims. In some embodiments, the operational service platform is configured to uniquely identify one or more parties in the claim. In some embodiments, the operational service platform is configured to link the one or more identified parties to a healthcare transaction or claim.

In some embodiments, the operational service platform is configured to receive, by the one or more processors, an ID request from a client system (e.g., web-connected administrative system). In some embodiments, the ID request includes a request to append a master ID to each respective record in a third-party system. In some embodiments, the operational service platform is configured to identify, by one or more processors, one or more ID parameters associated with the ID request and/or each respective record. In some embodiments, the operational service platform is configured to consolidate, by one or more processors, the one or more ID parameters into a master ID parameter. In some embodiments, the operational service platform is configured to append, by one or more processors, the master ID parameter to each of one or more respective records in the third-party system. In some embodiments, if a record cannot be associated with a master ID, the system is configured to generate a list of unverified records. In some embodiments, the system is configured to generate a GUI comprising the list of unverified records. In some embodiments, the system is configured to enable a user to manually generate a master ID comprising one or more ID parameters for each of the unverified records.

In some embodiments, one or more program instruction steps are configured to implement a sequence. In some embodiments, the sequence includes steps for identifying and matching all data elements to individual ID parameters including names, identifiers, variations, eligibility, claims, payments, as non-limiting examples. Some embodiments comprise a step to attempt a name and/or address match with master ID records. Some embodiments comprise a step to attempt a match with variations records. Some embodiments comprise a step to data prep the name. Some embodiments comprise a step to verify and/or perfect the address. Some embodiments comprise a step to attempt, by the one or more processors, a name and address match with variations. Some embodiments comprise a step to access external references and/or services and/or prioritize them by accuracy and/or cost. Some embodiments comprise a step to execute match logic. Some embodiments comprise a step to encrypt reference and/or variations and/or write each to a parallel free text database. Some embodiments comprise a step to apply, by one or more processors, artificial intelligence (AI) models configured to execute the matching. Some embodiments comprise a step to generate a graphical user interface for manual matching if all system executed match attempts fail.

In some embodiments, the operational service platform is configured to generate one or more GUIs. In some embodiments, the operational service platform includes a variations table. In some embodiments, the operational service platform is configured to execute a correction step that includes properly capitalizing ID parameters. In some embodiments, the operational service platform includes an identifier and linkage table. In some embodiments, the operational service platform is configured to add a CMS National Provider Identification standard (NPI) to one or more records. In some embodiments, the operational service platform includes an automated match logic system.

In some embodiments, the operational service platform is configured to link to a population platform which includes a population variations table. In some embodiments, the variations table includes multiple (different) record IDs for the same individual. In some embodiments, the operational service platform is configured to execute, by one or more processors a consolidation of the one or more records into one or more single instances of each variation. In some embodiments, the system is configured to generate, by one or more processors, a master ID that is linked to each variation. In some embodiments, the system is configured to return, by one or more processors, the master ID to a client computer in response to a request and/or entry that includes an ID variation. In some embodiments, the operational service platform is configured to identify individuals within a same household. In some embodiments, the operational service platform is configured to link one or more records of individuals within the same household.

In some embodiments, the operational service platform is configured to link to an address platform that includes an address variations table. In some embodiments, the address platform is configured to create an initial address using unique addresses in provider and population databases.

In some embodiments, the operational service platform is configured to link to an organization platform that includes an employee variations table. In some embodiments, the operational service platform is configured to delete duplicate variations in the organization platform and/or generate a master ID linked to all employee ID variations.

In some embodiments, the operational service platform is configured to link healthcare practitioners to population and personal information and/or healthcare organizations to organization and business information. In some embodiments, the operational service platform includes identification resolution for individuals and organizations incorporating all the above databases, tables, platforms, systems, and associated IDs. In some embodiments, the operational service platform includes an operational Identifier and Refining Web service. In some embodiments, the operational service platform includes a Provider Network Management System.

Referring back to Table 1, in some embodiments, the instructions include one or more program steps for implementing a match algorithm. Some embodiments comprise a step to parse, by one or more processors, each ID (e.g., name) variation. Some embodiments comprise a step to apply multi-name logic rules to each ID variation. Some embodiments comprise a step to match each ID variation to a master ID (e.g., master name). Some embodiments comprise a step to match a master ID to each ID variation. Some embodiments comprise a step to apply match logic. Some embodiments comprise a step to check for the ID (e.g., name) in one or more platforms (e.g., Address platform, Organization platform, etc.). Some embodiments comprise a step to interface, by one or more processors, with an ID finder service (e.g., name finder website) and search for the ID parameter via the ID finder service. Some embodiments comprise a step to interface, by one or more processors, with one or more credit agencies and/or commercial databases (e.g., Facebook®, Google®, advertising services, etc.). Some embodiments comprise a step to generate, by one or more processors, a GUI configured to enable a user to initiate one or more of a manual web search, a phone call, and manual edits.

Some embodiments comprise a step of the match logic matching last name and first character of the first name. Some embodiments comprise a step to determine, by the one or more processors if the first and last names are reversed. Some embodiments comprise a step of the match logic including 4 or less digits of the 5-digit Zip code. Some embodiments comprise a step to use only the name of a street. Some embodiments comprise a step to search in a 5 to 10-mile radius. Some embodiments comprise a step of the match logic implementing, by one or more processors, an AI matching algorithm after logical processes fail. By not implementing the AI matching algorithm until after logical processes fail, computer resources are saved according to some embodiments.

In some embodiments, the system is configured to collect healthcare provider and patient data and all related participant and claims data from in tens of thousands of administrative systems in doctors' offices, medical groups, hospitals, pharmacies, laboratories, provider networks, insurers, claims administrators, HMOs, claims routing networks, analysis and repricing companies, governmental systems, and in many billions of claims records generated throughout the healthcare enterprise. In some embodiments, the system is configured to consolidate and/or link patients, providers, provider networks, fee schedules, plan identifiers and related identifiers and codes used in healthcare claims that contain inaccuracies in the form of variations.

In some embodiments, the system is configured to interface with one or more healthcare systems to receive and analyze claims generated by providers, medical groups, hospitals, pharmacies, and radiologists. The claims are submitted to administrative systems or routed through intermediate claims adjustment organizations. In some embodiments, the system is configured to receive and analyze claims sent to provider networks for repricing. In some embodiments, the system is configured to interface with one or more specialty organizations such as radiology, psychiatric and outpatient surgery organizations to intercept and analyze cases during the approval process. In some embodiments, the system is configured to determine when a claim has been mis-assigned to a provider network. In some embodiments, the system is configured to analyze a healthcare database to determine mis-assignment and/or mislabeling of one or more patient record IDs.

In some embodiments, the system is configured to receive data from any source in healthcare and/or receive changes in near real time. In some embodiments, the system is configured to edit, identify, and/or match all record IDs to the insurer's master ID. In some embodiments, data from all participating organizations are related and mapped to an insurer's predetermined format which speeds up the claims adjudication process. The systems' intervention during record transfer results in cost and time savings according to some embodiments.

In some embodiments, the system is configured to ensure the identities of patients and providers in a claims system align with provider identifiers (IDs) in networks and all claim intermediaries. Often overlooked are the identification problems in the claims system. Incoming claims from many sources introduce different identities of the same provider. A claim from a medical group may not even identify the attending practitioner. Claims examiners must process a minimum number of claims and may assign a new ID to a provider or patient. It is not uncommon to have a provider with 5 to 15 different identities in a claims system.

In some embodiments, the system is configured to uniquely identify and align providers in a claims system. In some embodiments, the system uses one or more methods and/or steps described herein to add the correct identifiers to claims records without breaking the claims audit system. In some embodiments, the operational service platform is configured to align provider and patient identifiers across multiple claims systems and maintain them over time.

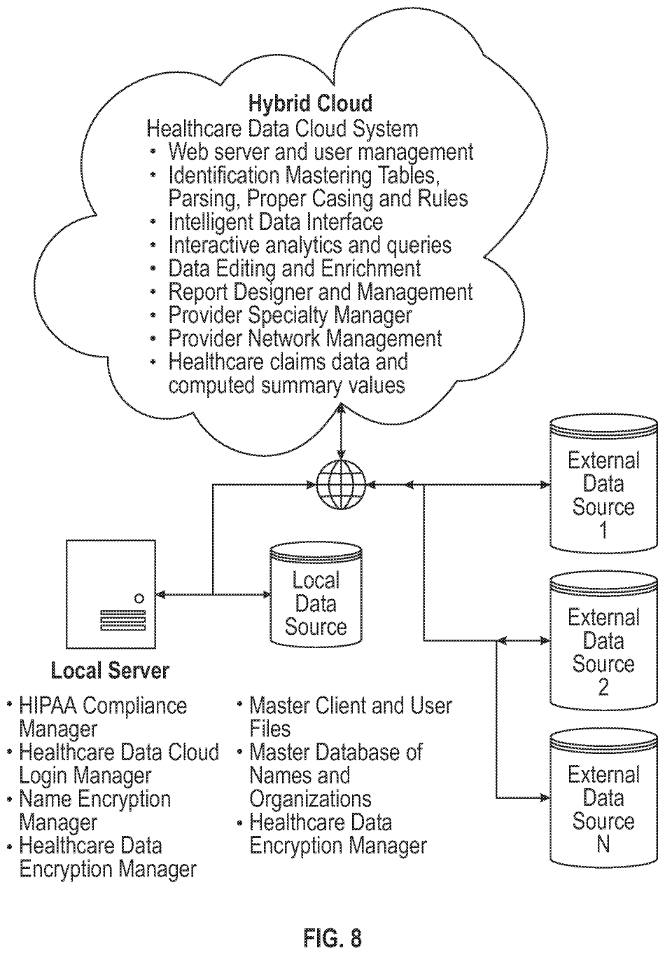

In some embodiments, operational service platform is configured to create, by the one or more processors, a bi-directional crosswalk table where the providers and patient names and identifiers residing in any healthcare administration system are uniquely identified and linked to a Universal ID. In some embodiments, the operational service platform is configured to link the names and identifiers located in a claims administration provider table that are the same entity to the same master ID (i.e., Universal ID) in the bi-directional crosswalk table. In some embodiments, the same process is applied to a patient table. In some embodiments, the system is configured to display, by one or more processors, all variations of one or more IDs identified by the system as associated with the same individual. FIG. 8 shows a bi-directional crosswalk table according to some embodiments.

In some embodiments, the system is configured to enable a claims administrator to access the bi-directional crosswalk table to uniquely identify providers and patients through a GUI, allowing proper claims adjudication and reporting. In some embodiments, the bi-directional table is generated by the operational service platform. In some embodiments, the operational service platform is configured to be incorporated into a data entry administrative system for uniquely identifying patients and providers in healthcare at each point of data entry.

In some embodiments, one or more steps of provider data refinement and ID matching includes receiving provider data, which includes IDs, from one or more sources and matching each ID to a master ID and related IDs to one or more other identifiers and related data in the operational service platform. In some embodiments, plan members and patients are identified with system functions. In some embodiments, the system is configured to link patients to individual providers, medical groups, and health plans. In some embodiments, the system is configured to monitor record ID entries across all participating health plan platforms.

In some embodiments, the system is configured to enable a client to provide a patient and/or provider table from a claims system and/or multiple claims systems and the operational service platform is configured to create and maintain a cross index table relating all records in all systems to universal identifiers (master IDs) for plan members, patients, individual providers, provider groups and health plans, provider network relationships, etc. In some embodiments, the operational service platform generates a master ID which includes a link to the plan member and provider identification for a health plan, all claims, utilization, diagnoses, and procedures are then related. In some embodiments, using an organizations' related claims data, the operational service platform is configured to calculate, by one or more processors, key measurement values for plan members, patients, providers, medical groups, provider networks and health plans. In some embodiments, the key measurement values include one or more geographic definitions over any time period.

In some embodiments, the system is configured to document provider relationships through the recording and/or assignment of identifiers which include one or more provider network affiliations, health plan contracts, relationships among individual providers and healthcare organizations such as medical groups, hospitals, laboratories, pharmacies, educational facilities, research facilities, etc. In some embodiments, the operational service platform is configured to create a model of a network by geography, provider type, specialty, and/or performance measures.

In some embodiments, the operational service platform is configured to receive, store, and/or access (e.g., through one or more APIs) provider practitioners and organizations (e.g., 6.2 M) names, alternate and historical names, addresses, phone numbers, specialties, group relationships, identifiers, licenses, and/or all variations and errors for all data elements. In some embodiments, each are retained, date-stamped, transaction types recorded, and/or related to all entities. In some embodiments, transaction history (e.g., 16+ years of monthly CMS NPI updates) are incorporated into the variations table, date-stamped and used to identify and correct historical records.

In some embodiments, the operational service platform is configured to refine and match individual names to the population platform (database) which include alternates and historical names, addresses, phone numbers, family relationships, birthdates, gender, and other identifiers. In some embodiments, financial information, variations, and errors for all data elements are retained, date-stamped, and transaction types recorded and related. In some embodiments, providers and patients are uniquely identified on a claim by the system. In some embodiments, prescriber and patient are uniquely identified on a prescription claim by the system.

Some embodiments comprise a step to match existing practitioners used by plan members to provider network practitioners and organizations. Some embodiments comprise a step to determine driving distance for members to local providers. Some embodiments comprise a step to generate a provider list for members, families, and seniors. Some embodiments comprise a step to receive and/or apply provider inclusion and exclusion rules (e.g., automatically and/or using filters). Some embodiments comprise a step to check for orphaned plan members and providers in one or more records. Some embodiments comprise a step to integrate one or more healthcare networks and/or integrate into one or more healthcare networks. Some embodiments comprise a step to apply specialty carveout rules. Some embodiments comprise a step to integrate disease-specific specialty providers into local networks. Some embodiments comprise a step to incorporate client data and/or apply an inclusion filter to the provider selection.

In some embodiments, the operational service platform includes provider directories. In some embodiments, provider directories include member specific personal provider directories. In some embodiments, the system is configured to compose directories and/or electronically distribute the directories. In some embodiments, the system is configured to compose geographic directories for printing.

In some embodiments, the system includes a provider module. In some embodiments, the provider module includes one or more of a web provider, a phone application provider finder, and a plan and network-specific provider finder support function.

In some embodiments, the system includes a provider and member identifier application (HIPAA Clean Room function) operating within an operational web service clean room, which uniquely identifies plan members or patients and healthcare practitioners and organizations submitted by a client and matches them to the client's internal ID. In some embodiments, the HIPAA clean room function is configured to be implemented within a clean room within the operational service platform and contains a proprietary database of plan members, patient, and/or healthcare provider assigned master IDs which are uniquely matched to one or more client entities tagged with multiple different client IDs. In some embodiments, the clean room includes a virtual collaboration network that enables data to be shared between parties without revealing raw data and/or the source of the data. In some embodiments, the clean room function automatically removes identifying information before it is shared between parties. In some embodiments, the clean room function is configured to enable access to a provider's medical records while removing any identifying information about the patient before returning requested data.

In some embodiments, the HIPAA Clean Room function enables clients to submit an entity name and internal anonymous ID. In some embodiments, the operational service platform returns a Universal ID along with one or more client anonymous IDs identifying the same entity. In some embodiments, the system is configured to enable the client computer to match the anonymous IDs to the client's internal IDs and/or create an internal table linking all entities that have multiple IDs. The HIPAA Clean Room function is configured to receive the name, anonymous ID, address, and/or other information. In some embodiments, the operational service platform is configured to return one or more of a Universal (master) ID, entity name, address, phone and/or other pre-defined information.

In some embodiments, in the HIPAA clean room, a large majority of transactions match a client's external IDs for an entity to a single operational service platform universal ID (UID). In some embodiments, the system is configured to enable a client to identify all instances and identities of a healthcare practitioner, organization, patient, or plan member across the enterprise allowing for accurate claims adjudication, analysis, and reporting. In some embodiments, the clean room includes a secure software package with two or more encrypted portals. In some embodiments, a client-side portal accepts encrypted data with client anonymous external IDs, names, addresses, phones, and other IDs that are sent to the HIPAA Clean Room Web application through a two-layer interchange. In some embodiments, the system-side portal communicates with a HIPAA Clean Room Web application through a two-layer interchange and connects to the Operational Web Service cloud-based Web Service through an encrypted VPN. In some embodiments, the Operational Web Service processes all client transactions that require refining and identification and data updating. In some embodiments, all client submissions of internal IDs are processed within an externally hosted HIPAA Clean Room and never communicate with the operational service platform (Operational Web Service). In some embodiments, the client relates the external ID to the client internal ID only within the secure protected health information (PHI) enclave.

In some embodiments, the system includes HIPAA clean room web application operational process steps implemented by the program instructions. In some embodiments, an application engine runs on the client cloud or server in a secure package. In some embodiments, the application manages the updating of a client's provider and plan member data including a UNIVERSAL ID, the client's external ID and name, address, phone number, and other information on the client device. Some embodiments comprise a step to return provider and plan member information in response to inquiries from within the client's enterprise. In some embodiments, if the entity is not located in the HIPAA Clean Room tables, a step includes the application querying the Operational Web Service for the information and/or updating the Web application tables with the corrected information and/or sending information to the client's application or user. In some embodiments, when the Operational Web Service processes an update to any entity located in the client's HIPAA Clean Room, a step includes to transmit the update and/or direct the HIPAA Clean Room to manage the update of the client's applications. In some embodiments, the client and the operational web service never communicate directly. In some embodiments, the system is configured to enable both parties to submit encrypted data to the HIPAA Clean Room application which processes all transactions.

Some embodiments include a step for clean room implementation that includes instructions for the clean room host computer to extract provider and plan member tables from one or more administrative and claims management system from a client's enterprise systems. Some embodiments comprise a step of the Operational Web Service refining and uniquely identifying all individuals and organizations across all systems and/or adding them to an operational table with indexes and relationship links between all entities. In some embodiments, the data is loaded into the HIPAA Clean Room and installed onsite in the client's enclave inside the Operational Web Service Clean Room.

In some embodiments, the system includes a social support eligibility identification module. In some embodiments, the social support eligibility identification module is configured to find individuals that may qualify for government-supported health plans such as 340B, Medicaid and other Federal and state programs. In some embodiments, the social support eligibility identification module is configured to interface the operational service platform. In some embodiments, the social support eligibility identification module is configured to determine eligibility for government programs using one or more of: household income range, credit rating range, credit cards, home ownership and/or mortgage data, as non-limiting examples, received from the operational service platform.

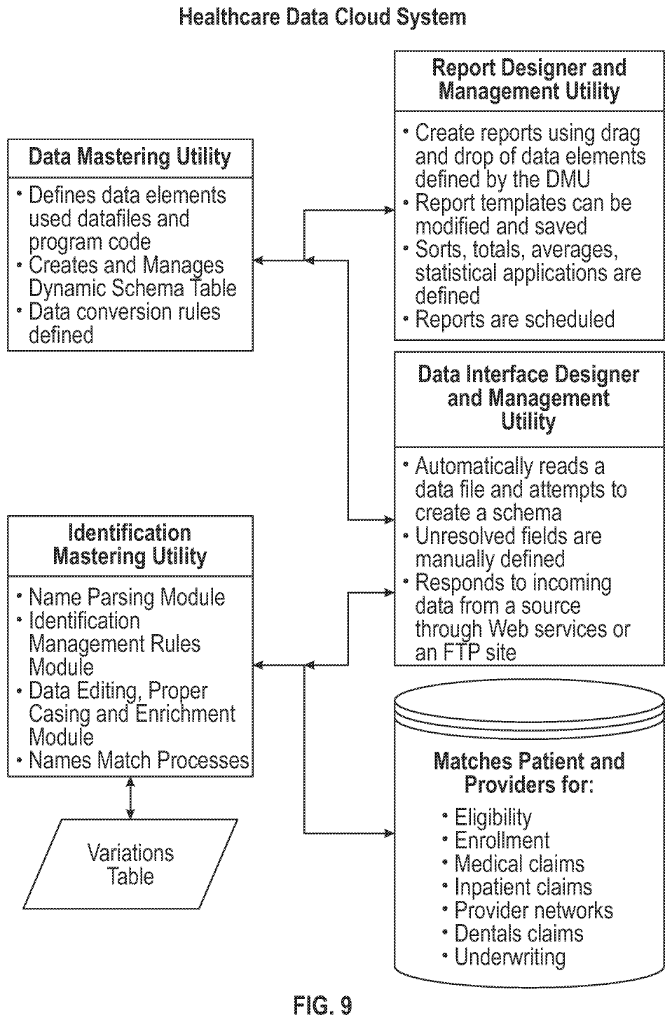

In some embodiments, the system is configured to generate a client user interface. In some embodiments, the client user interface is configured to allow customization of viewable web pages, number of tables, columns, column order, row sort, column inclusion, data access, edit rights, record additions, reporting rights, data set additions, reporting, and/or other property rights. The operational service platform is configured to enable clients to load patient data and/or grant access privileges to only their data in conjunction with one or more features described herein according to some embodiments. In some embodiments, pages are configured to restrict the client user to only certain data with specific privileges and/or access rights. FIG. 9 illustrates a privilege table according to some embodiments.

In some embodiments, the system includes an eligibility and provider process. Some embodiments comprise a step of enabling the client to create a synthetic or tokenized ID that relates to the database system internal ID. Some embodiments comprise a step of the system enabling clients, through a secure encrypted portal, to insert data labelled with a synthetic ID into the clean room. In some embodiments, data includes provider data or eligibility (name, address, Ph No, etc) of a provider, where the NPI may be included. Some embodiments comprise a step of the system enabling client data to be inserted into a read-only table in a HIPAA Data Clean Room. Some embodiments comprise a step of the system enabling the Operational Web Service Services to enter the HIPAA Data Clean Room through a secure encrypted portal through a secure VPN. Some embodiments comprise a step of the system enabling the Operational Web Service to read the data in the read-only table. Some embodiments comprise a step of the system enabling the Operational Web Service to create its own synthetic ID and/or encrypt the data. Some embodiments comprise a step of the system enabling the clean room to transmit the data to the Operational Web Service.

Some embodiments comprise a step of the operational web service verifying the address. Some embodiments comprise a step of the operational web service attaching enhanced geographical data (e.g., latitude, longitude, County, ZIP-9, etc.). Some embodiments comprise a step of the operational web service matching names and/or determining correct and/or master ID information. Some embodiments comprise a step of the operational web service attaching the master (universal) ID to the patient (client) record. In some embodiments, it is possible to have more than one record with the same Universal ID if there are variations in the name.

Some embodiments comprise a step of the operational web service is configured to transmit the modified patient record back to the clean room. In some embodiments, data is written into an exactly matching Vendor table along with the corrected data with the clients' synthetic ID included as well as the Universal ID and NPI number which may also be corrected. In some embodiments, If the data could not be matched a code is inserted detailing the failure mode. In some embodiments, the system is configured to generate and/or send a report with a completion code and/or processing statistics. In some embodiments, the system is configured to generate a GUI to enable a user to read the data from the vendor table.

In some embodiments, the system includes a medical claims and prescription claims process. In some embodiments, process is the same except the provider and patient data are extracted from the claim and the claim is assigned a client synthetic ID. In some embodiments, after the data in the claims are cleaned and refined the data are sent to the clean room where the data are inserted back into the claim along with universal IDs into the vendor table that is exactly aligned with the client table. In some embodiments, if claims data are analyzed and profiles created the Operational Web Service processes will be applied within the clean room.

Some embodiments comprise a step of the operational web service creating the provider variations table. Some embodiments comprise a step of the operational web service cleaning and applying proper casing to all practitioner names and organizations names and addresses throughout Operational Web Service. Some embodiments comprise a step of the operational web service recording every variation of individual names and organization names, addresses, phone numbers, specialties, and other information in CMS NPI monthly and weekly updates. Some embodiments comprise a step of the operational web service recording the changes (variations) and data sources and increment accumulators. Some embodiments comprise a step of the operational web service reporting new records additions and retired NPIs upon request.

In some embodiments, Transaction types include name changes, variations of a name, doing business as, new names, retired names, deceased names, and/or a new identifier. In some embodiments, the processing of every client record submitted is linked to a transaction type and a t ID and/or recorded with a date and time stamp in a master transaction record that can never be altered by any system or person not authorized to do so. In some embodiments, billing is based on records in the file and are auditable. The following is a non-limiting example of transaction types and codes according to some embodiments:
1. Record processed with no changes
2. Practitioner new added
3. Practitioner name change
4. Practitioner name variation
5. Practitioner address change
6. Practitioner additional address
7. Practitioner address use code
8. Practitioner specialty addition
9. Practitioner NPI retired
10. Practitioner phone number addition
11. Practitioner deceased
12. Practitioner identifier and type added
13. Practitioner provider add network ID
14. Practitioner provider terminated network ID
15. Healthcare organization new added
16. Healthcare organization name change
17. Healthcare organization name variation
18. Healthcare organization name “Doing Business As”
19. Healthcare organization address change
20. Healthcare organization additional address
21. Healthcare organization address use code
22. Healthcare organization specialty addition
23. Healthcare organization NPI added
24. Healthcare organization NPI retired
25. Healthcare organization phone number addition
26. Healthcare organization ceased business
27. Healthcare organization identifier and type added
28. Healthcare organization add provider network ID
29. Healthcare organization terminated provider network ID
30. Person new added
31. Person name change
32. Person name variation
33. Person address change
34. Person additional address
35. Person address use code
36. Person birth date update
37. Person phone number add/change
38. Person deceased
39. Person identifier and type added
40. Person household relationship/type ID added/updated
41. Organization new added
42. Organization name change
43. Organization name variation
44. Organization name “Doing Business As”
45. Organization address change
46. Organization additional address
47. Organization address use code
48. Organization business type update/addition
49. Organization ID added
50. Organization ID retired
51. Organization phone number addition/change
52. Organization ceased business
53. Organization identifier and type added
54. Organization adds related/type ID
55. Employee new added
56. Employee Population ID
57. Employee title update/change
58. Employee address change
59. Employee additional address
60. Employee address use code
61. Employee employment date update
62. Employee phone number add/change
63. Employee termination date
64. Employee identifier and type added
65. Employee function relationship/type ID added/updated

In some embodiments, the system is configured to accumulate the count of transaction by type by data source. In some embodiments, the system is configured to record the first date and time of a transaction and the most current date. In some embodiments, the system is configured to sum the counts for a specific transaction for all data sources. In some embodiments, the system is configured to record all variations in the link table.

In some embodiments, the system is configured to load population data into a population database in the population platform. In some embodiments, the system is configured to apply a master ID to all data elements in the population database. In some embodiments, the system is configured to identify a range of all data element entries and validation formatting. In some embodiments, the system is configured to log the percentage of entries for each data element.

Some embodiments include a step in creating the population and/or variations tables that includes removal of all organizations from the population table. Some embodiments include a step in creating the population and/or variations tables that includes consolidating the records that are for an individual into one record with variations. In some embodiments, there is a key that links individuals to their common records. In some embodiments, the difference in the common records is usually an address change although a name change is also possible if a woman has been married. In some embodiments, the system is configured to use the insert date at the end of the records to determine which record is the most recent entry. In some embodiments, all other records become variations. In some embodiments, there are some records for individuals that are not linked by a common key which necessitates matching all records by name and birthdate or cell phone by the system. In some embodiments, the system is configured to use the household key to determine the individuals in the same household. In some embodiments, many people with different names may be matched to an address giving the appearance that more than one family is living in the same household at the same time. In some embodiments, the system is configured to check the record insert dates to determine if one family moved out from an address and another family moved in, so that the families are not recorded living in the same household at the same time.

In some embodiments, using the methodology of the variations table in the provider database, the system is configured to create a variations table appropriate for the population table. In some embodiments, most of the variations will be address changes. In some embodiments, the system is configured to generate household statistics. In some embodiments, the income, home ownership and value, interests, and work is based on the data for the adults. In some embodiments, the household income may not be additive because it may be consolidated with each adult. In some embodiments, the value of the house should be the same for all adults in the household. In some embodiments, the system is configured to take this into account when analyzing household data for consolidation. In some embodiments, the system is configured to record and/or date stamp all variations and add the variations to the link table. In some embodiments, the system is configured to make all population data searchable and viewable in the UI.

In some embodiments, the system includes a setup organization database (DB) and/or an employee database. In some embodiments, the organization DB includes one or more (e.g., up to 10) employees with name, gender, title, and/or contact ID. In some embodiments, the system is configured to extract contacts and related information along with the organization ID and address and insert into the employee DB. In some embodiments, the system is configured to extract individuals in an email database (e.g., B2B) and load them in employees DB. In some embodiments, the system is configured to create the variations table for the organization database. In some embodiments, the system is configured to record and/or date stamp all variations and add to link table.

In some embodiments, the system is configured to link healthcare practitioners to their identities in the population database. In some embodiments, the system is configured to link healthcare organizations to their identities in the organizations database. In some embodiments, the system is configured to Link Organization Employees to their identities in the Population database. In some embodiments, the system is configured to bidirectionally link healthcare organizations and practitioners.

In some embodiments, the system is configured to link one or more addresses in one or more databases to the address platform. In some embodiments, the system is configured to extract unique, verified addresses from the provider, population and organization platforms and associated databases. In some embodiments, the system is configured to create and/or master (i.e., assign a master ID) to the addresses. In some embodiments, the system is configured to create an address variation database.

In some embodiments, the system is configured to identify and/or match providers and patients in a claim. In some embodiments, the system includes matching steps. Some embodiments include a matching step that includes putting all names for individuals and organizations into a vector. Some embodiments include a matching step that includes removing spaces and control characters from the vector. Some embodiments include a matching step that includes placing each word in the vector in the correct pre-determined order, (e.g., first, middle, last suffix, and degree). Some embodiments include a matching step that includes labeling each ID. Some embodiments include a matching step that includes labeling each word by type (e.g., first, middle, last, address number, street, etc.). In some embodiments, the system is configured to apply matching steps to any platform and/or ID described herein.

In some embodiments, healthcare practitioners and healthcare organizations identification and corrections submitted from external sources are automated by the system. In some embodiments, the system includes a web service automated processing operated and managed through the GUI. In some embodiments, the system includes a client-specific patient and provider crosswalk table. In some embodiments, the system includes a bidirectional crosswalk system as a web service with a direct client connection. In some embodiments, the system is configured to provide provider network management system (network) access plan member data with family IDs and addresses, age, gender, dependents submitted from an external data source. In some embodiments, the system includes a model provider network for the plan members. In some embodiments, the system is configured to provide providers currently used by plan members. In some embodiments, the system is configured to provide a mix of providers appropriate to the family member age mix. In some embodiments, the system is configured to compute driving distance to closest providers for plan members. In some embodiments, the system is configured to enable a user to filter by one or more of star rating, referral patterns, prescribing patterns, OID exclusions, fee schedules, and/or narcotic prescribing, as non-limiting examples. In some embodiments, the system is configured to filter provider inclusion/exclusion based on the criteria in claims and other data sets including client data. In some embodiments, the system is configured to filter by prevention and/or treatments of conditions.

In some embodiments, the system includes a graphical user interface (GUI) configured to enable one or more of a secure login, administration access, access rights, edit rights, reporting, and/or analysis. In some embodiments, the GUI includes one or more of provider data, population data, organization data, network and design. In some embodiments, the GUI is configured to enable uploading of one or more data sets for analysis. In some embodiments, the system is configured to enable uploading of one or more provider lists (e.g., via NPI or network), patient lists, and/or drug lists, as non-limiting examples. In some embodiments, the GUI includes a reporting section. In some embodiments, the GUI includes an administrative section.

In some embodiments, the system includes a data mastering utility (DMU). In some embodiments, the DMU is configured to enable external database access. In some embodiments, the DMU is configured to enable a client to create a healthcare data table for providers, patients, claims, and/or any similar data set. In some embodiments, the DMU is configured to enable the created datasets to be loaded in the operational service platform. In some embodiments, the operational web service is configured to execute one or more of: identification of all entities; identification and loading of all data columns into one or more operational web service data tables; establish one or more (e.g., all) searchable data columns or format one or more columns based on data type. In some embodiments, the system is configured to enable a user to immediately sort, edit, filter, sum, analyze, report, and/or export the data in any format.

In some embodiments, the DMU is configured to describe one or more data elements. In some embodiments, the one or more data elements are stored in one or more of a database or a table and embedded into a computer program. In some embodiments, the system is configured to link one or more field labels from one or more data sources. Some non-limiting examples include schema such as field name or variable name, format, data type, size and/or other database attributes according to some embodiments. In some embodiments, the system is configured to execute data conversions. In some embodiments, data translation attributes can be specified between a data source and the operational service platform, and the system is configured to apply data conversion applied automatically (e.g., meters to feet, kilograms to pounds, etc.).

FIG. 10 illustrates a dynamic schema table model according to some embodiments. In some embodiments, the dynamic schema table model includes the illustrated attributes and/or is extensible. In some embodiments, the dynamic schema table model includes definitions for how to format a field in a report and is used by the report designer and the data interface and management utility.

In some embodiments, the operational service platform is configured to enable the addition of one or more schema tables. In some embodiments, the operational service platform is configured to automatically format one or more of healthcare data fields, the search attributes, table layouts, and/or column sequence. In some embodiments, the system is configured to: add data column headings, apply formatting, and/or apply column widths and apply sort order. In some embodiments, the system is configured to automatically identify providers and/or patients. In some embodiments, the system is configured to automatically summarize table content.

Some non-limiting examples of dynamic definitions of data tables, column order, sort include one or more of input field selection, output field selection, table field order, report headers, table sort order, dynamic table column labels, standard sum, accumulators, averages, mean columns, where the system is configured to insert each. In some embodiments, the system includes a variations table. In some embodiments, the variations table includes changes. In some embodiments, changes include one or more of a change in a name, address, phone, and/or identifier, as non-limiting examples.

In some embodiments, the variations table includes variations. In some embodiments, variations include names and/or addresses with changes (e.g., in spelling and/or word sequence of multiple first, middle, and/or last names in compound names). In some embodiments, the variations table includes doing business as (DBA) designations, which includes various legal names of an entity in some non-limiting examples. In some embodiments, the variations table includes “applied to names” of people, organizations, addresses, phone numbers, specialties, identifiers such as NPI, SSN, member ID, Patient ID, network ID, claims ID, etc.

In some embodiments, the variations table includes data preparation by the system. In some embodiments, data preparation includes parsing names, proper casing, perfecting addresses, as non-limiting examples. In some embodiments, the variations table includes update logging. In some embodiments, update logging includes one or more of type of change, date/time change, data source, cumulative count, and linkage table.

In some embodiments, the variations table includes CMS NPI updates. In some embodiments, CMS NPI updates are the most complex, include lots of data anomalies, and includes (e.g., 68 months of) history. In some embodiments, 68 monthly NPI updates are configured to be processed sequentially and/or record every change. In some embodiments, the resulting variations and linkage files are configured to be used in the matching process.

In some embodiments, variations tables are applied to one or more of people's names, addresses, diagnoses, provider specialties, organization names, geographic definitions, procedures, SIC, NAICS codes, organization business categories, table column definitions, natural language processing.

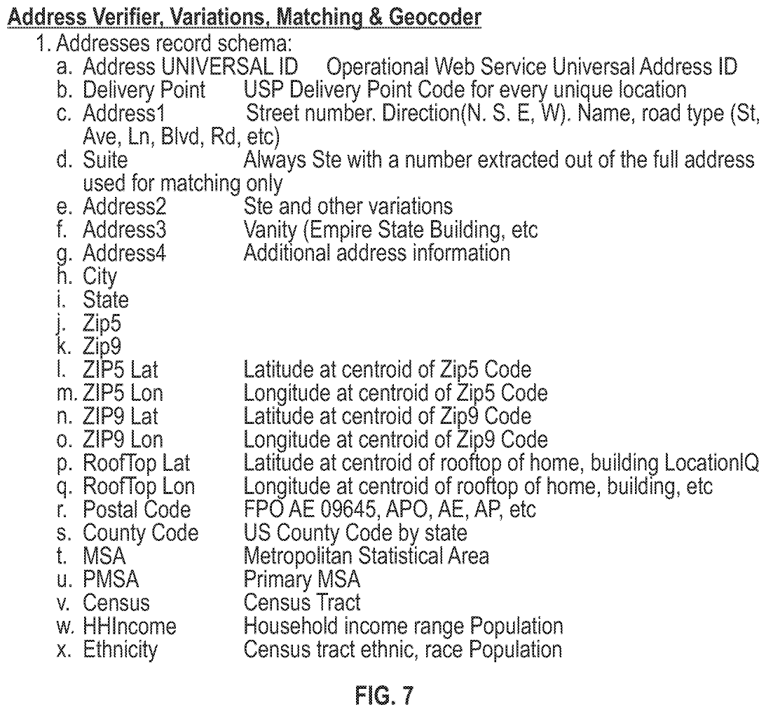

In some embodiments, the system functionality includes one or more of an address verifier, variations, matching, and geocoder. FIG. 7 shows a non-limiting example of an address record schema according to some embodiments. In some embodiments, the system includes population addresses. In some embodiments, the system is configured to match addresses in the address verifier, where the variations are recorded. In some embodiments, the addresses from the population and organization data sets are included. In some embodiments, one or more program steps include an order of execution. In some embodiments, that includes: (a) execution of an operational web service address verifier; (b) Reference Lookup execution, which may include, as a non-limiting example, a ZIP-Codes.com database search for 9-digit zip codes latitude and longitude and/or 50 m unique street names with the range of street numbers and the termination points of the street; (c) execution of a location IQ for rooftop latitude and longitude and mapping; (d) execution of an access external verifier when the operational web service (operational service platform) verifier fails and for use as the verifier for the UI.

In some embodiments, the operational web service address verifier is configured to execute a series of steps. Some embodiments comprise a steps that include one or more of:
(a) addresses pre-processing to move the suite, office, apt bldg number to address 2;
(b) extracting the unique addresses and rooftop latitude and longitude from the Population database and labeling the addresses as Residential R;
(c) extracting the unique addresses and rooftop latitude and longitude from the organization database and/or labeling the addresses as commercial C;
(d) extracting the unique verified addresses from the CMS provider data and/or labeling them Provider P;
(e) loading all unique addresses in the master address database and sorting them by street number;
(f) matching the provider addresses with addresses from population and organization and removing the provider duplicates;
(g) using the ZIP-Codes.com data to add the county, state, MSA, PMSA and census tract code to the address record;
(h) generating an Address Verifier Variations table;
(i) executing a matching algorithm;
(j) executing the operational web service address verifier application programming interface (API); and
(k) adding the UNIVERSAL ID to all addresses.

In some embodiments, the system includes an organization module. In some embodiments, the organization module includes employees. In some embodiments, the organization module comprises a plurality of records (e.g., 24 million records) with business information and related officer and management records. In some embodiments, a related B2B Email file includes a plurality (e.g., 60 million) records on individual and/or some limited organization data linked to the organization module. In some embodiments, the system is configured to generate an employee file which includes one or more individuals in the organization and B2B Email file. In some embodiments, the system is configured to consolidate (all) business information in the organization module.

In some embodiments, the system includes a provider network management (PNM) platform. In some embodiments, the PNM platform is configured to access plan member data which includes family IDs, addresses, age, gender, and/or dependents, as non-limiting embodiments. In some embodiments, the PNM platform is configured to create a model provider network for the plan members.

In some embodiments, the PNM platform is configured to add a mix of providers appropriate to the family member age mix (i.e., family practitioners and geriatric physicians; hospitals, ancillary providers, etc.).

In some embodiments, the PNM platform is configured to compute driving distance to closest providers. In some embodiments, the PNM platform is configured to filter provider selection by one or more of star ratings, referral patterns, prescribing patterns, Office of Inspector General (OIG) exclusions, fee schedules, and narcotic prescribing.

It is understood that the invention is not limited in its application to the details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Furthermore, acting as Applicant's own lexicographer, Applicant defines the use of and/or, in terms of “A and/or B,” to mean one option could be “A and B” and another option could be “A or B.” Such an interpretation is consistent with ex parte Gross, where the Board established that “and/or” means element A alone, element B alone, or elements A and B together.

Some embodiments of the system are presented with specific values and/or setpoints. These values and setpoints are not intended to be limiting and are merely examples of a higher configuration versus a lower configuration and are intended as an aid for those of ordinary skill to make and use the system. In addition, “substantially” and/or “approximately” when used in conjunction with a value encompass a difference of 10% or less of the same unit and scale of that being measured. In some embodiments, “substantially” and/or “approximately” are defined as presented in the specification.

The description is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data can be obtained over a network the data can be processed by other computers on the network, e.g., a cloud of computing resources.

Some embodiments of the present invention can be defined as a machine that transforms data from one state to another state. In some embodiments, the data can represent an article, that can be represented as an electronic signal and electronically manipulate data. The transformed data can, in some cases, be visually depicted on a display, representing the physical object that results from the transformation of data. In some embodiments, the transformed data can be saved to storage generally or in particular formats that enable the construction or depiction of a physical and tangible object. In some embodiments, the manipulation can be performed by a processor. The processor thus transforms the data from one thing to another. Still further, in some embodiments, the methods can be processed by one or more machines or processors that can be connected over a network. In some embodiments, each machine can transform data from one state or thing to another, and can also process data, save data to storage, transmit data over a network, display the result, or communicate the result to another machine. In some embodiments, computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way according to some embodiments.

We claim:

1. A system for training an artificial intelligence system comprising:
one or more computers comprising one or more processors and one or more non-transitory computer readable media, the one or more non-transitory computer readable media comprising program instructions stored thereon that when executed cause the one or more computers to:
receive, by the one or more processors, one or more identifiers for one or more individuals;
execute, by the one or more processors, a vectorization of the one or more identifiers, where the vectorization generates one or more vectors by transforming each of the one or more identifiers into a vector identifier;
generate, by the one or more processors, an array comprising the one or more vectors generated from each of the one or more identifiers; and
send, by the one or more processors, the array to an artificial intelligence module as a training set for the artificial intelligence system.

2. The system of claim 1,
wherein generating the one or more vectors comprises a character classification of one or more characters within each of the one or more identifiers.

3. The system of claim 2,
wherein the character classification includes separating text, strings, spaces, hyphens, periods, prefixes, suffixes, titles, and/or numbers into elements; and
wherein each of the one or more vectors comprise a plurality of the elements.

4. The system of claim 1,
wherein the one or more non-transitory computer readable media further comprise program instructions stored thereon that when executed cause the artificial intelligence to:
execute, by the one or more processors, a database search using the array; and
return, by the one or more processors, identifying information associated with a form of the one or more vectors.

5. The system of claim 4,
wherein the one or more non-transitory computer readable media further comprise program instructions stored thereon that when executed cause the artificial intelligence system to:
search, by the one or more processors, the identifying information for one or more identifier variations associated with the one or more individuals; and
store, by the one or more processors, the one or more identifier variations.

6. The system of claim 5,
wherein the one or more non-transitory computer readable media further comprise program instructions stored thereon that when executed cause the artificial intelligence to:
generate, by the one or more processors, one or more new vectors by transforming each of the one or more identifier variations into a new vector identifier; and
store, by the one or more processors, the one or more new vectors in the array to generate a new array.

7. The system of claim 6,
wherein the one or more non-transitory computer readable media further comprise program instructions stored thereon that when executed cause the artificial intelligence system to:
send, by the one or more processors, the new array to the artificial intelligence module as a new training set.

8. The system of claim 7,
wherein the one or more non-transitory computer readable media further comprise program instructions stored thereon that when executed cause the artificial intelligence system to:
repeat, by the one or more processors, additional database searches until no additional identifying information and/or identifier variations are discovered.

9. The system of claim 3,
wherein the one or more non-transitory computer readable media further comprise program instructions stored thereon that when executed cause the artificial intelligence system to:
generate, by the one or more processors, a unique identification for each of the one or more vectors in the array;
generate, by the one or more processors, a master identification configured to reference each unique identification; and
associate, by the one or more processors, the master identification with at least one of the one or more vectors.

10. The system of claim 1,
wherein the one or more non-transitory computer readable media further comprise program instructions stored thereon that when executed cause the artificial intelligence system to:
receive, by the one or more processors, a query comprising at least one instance of an identifier in the array; and
return, by the one or more processors, all records associated with each variation in the array for the one or more individuals.

11. A computer-implemented method for training an artificial intelligence system comprising steps that include:
receiving, by one or more processors, one or more identifiers for one or more individuals from one or more databases;
executing, by the one or more processors, a vectorization of the one or more identifiers, where the vectorization generates one or more vectors by transforming each of the one or more identifiers into a vector identifier;
generating, by the one or more processors, an array comprising the one or more vectors generated from each of the one or more identifiers; and
sending, by the one or more processors, the array to an artificial intelligence module as a training set for an artificial intelligence system;
wherein generating one or more vectors comprises a character classification of one or more characters within each of the one or more identifiers;
wherein the character classification includes separating text, strings, spaces, hyphens, periods, prefixes, suffixes, titles, and/or numbers into elements; and
wherein each of the one or more vectors comprise a plurality of the elements.

12. The computer-implemented method of claim 11, further comprising steps that include:
executing, by the one or more processors, a database search for a form of the one or more vectors; and
returning, by the one or more processors, identifying information associated with the one or more vectors.

13. The computer-implemented method of claim 12, further comprising steps that include:
generating, by the one or more processors, one or more new vectors by transforming each of one or more identifier variations into a new vector identifier; and
storing, by the one or more processors, the one or more new vectors in the array to generate a new array.

14. The computer-implemented method of claim 13, further comprising steps that include:
sending, by the one or more processors, the new array to the artificial intelligence module as a new training set.

15. The computer-implemented method of claim 14, further comprising steps that include:
repeating, by the one or more processors, additional database searches until no additional identifying information and/or identifier variations are discovered; and
sending, by the one or more processors, additional arrays generated during the repeating to the artificial intelligence module as additional training sets.

16. The computer-implemented method of claim 15, further comprising steps that include:
generating, by the one or more processors, a unique identification for each of the one or more vectors in the array;
generating, by the one or more processors, a master identification configured to reference each unique identification; and
associating, by the one or more processors, the master identification with at least one of the one or more vectors.

17. The computer-implemented method of claim 16, further comprising steps that include:
receiving, by the one or more processors, a query comprising at least one instance of an identifier in the array;
returning, by the one or more processors, all records associated with each variation in the array for the one or more individuals.

18. The computer-implemented method of claim 11,
wherein the one or more identifiers includes a proper noun.
